(19) United States
(12) Patent Application Publication
(10) Pub. No.: US 2011/0019208 A1
(43) Pub. Date: Jan. 27, 2011

(54) IMAGE DATA GENERATING APPARATUS, PRINTING APPARATUS, AND IMAGE DATA GENERATION METHOD

(75) Inventors: Hiromitsu Yamaguchi, Yokohama-shi (JP); Yoshitomo Marumoto, Yokohama-shi (JP); Hidehisa Mabuchi, Kawasaki-shi (JP); Eri Noguchi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/838,931

(22) Filed: Jul. 19, 2010

(30) Foreign Application Priority Data
Jul. 23, 2009 (JP) 2009-172437

(51) Int. Cl. G06K 15/02

(52) U.S. Cl. 358/1.2

(57) ABSTRACT

When error diffusion processing is applied to thinned printing, the thinned printing can be performed without spoiling the dot printing pattern, and dot data is generated so that occurrence of grain may be suppressed by the dot arrangement distributed by the error diffusion processing. Specifically, the error diffusion of the binary data is performed in consideration of permitted positions shown by a division pattern of a nozzle array. That is, the binary data is permitted to be arranged only at a pixel position indicated by black in the division pattern of the nozzle array. Next, the result of having subtracted binary data from multi-valued data is applied as correction data of a multiple value, and this correction data is added to cyan multi-valued data of the nozzle array of first pass related to second plane generation.

### BACKGROUND OF THE INVENTION

1. Field of the Invention

The present invention relates to an image data generating apparatus, a printing apparatus, and an image data generation method, and more specifically to distribution of print data to each nozzle in the case of performing printing in a resolution for nozzles ejecting inks lower than a print resolution.

2. Description of the Related Art

In the field of a printing apparatus, printing an image having high resolution at high speed is required in recent years. The so-called thinned printing is known as one configuration which achieves high-speed printing with high resolution. For example, when a print resolution of a main scanning direction is 1200 dpi at the time that a printing head that arranges nozzles for ejecting ink is scanned to print, the inks are ejected for pixels with the interval equivalent to 1200 dpi, respectively.

In this printing, use of a printing head provided with for example two nozzle arrays for ink of the same color allows the ink to be alternately ejected to the above described pixels with the interval equivalent to 1200 dpi from two nozzle arrays. In this case, the inks will be ejected from one nozzle array to the pixel with the interval equivalent to 600 dpi. Accordingly, when ejecting ink from a nozzle array at frequency at the time of performing printing in the resolution of 1200 dpi, a scanning speed of the printing head can be doubled compared with the case where the image of the resolution of 1200 dpi is printed by one scanning using one nozzle array. That is, a printing speed can be doubled. This explanation may apply similarly to a case where three or more nozzle arrays are provided.

Processing for distributing ejection (dot) data to a plurality of nozzle arrays such as two or three or more arrays as the mentioned above is explained as follows in a case that each of for example two nozzle arrays arranges 16 nozzles at the interval equivalent to 1200 dpi in a direction orthogonal to a main scanning direction. 1st, 2nd, 5th, 6th, 7th, 9th, 10th and 14th nozzles are used in the nozzle array of one side, and 3rd, 4th, 8th, 11th, 12th, 13th, 15th and 16th nozzles are used in the nozzle array of another side, in printing of a pixel array (hereinafter, referred to as a column) in the above-mentioned orthogonal direction. Then, when printing next column in scanning, the two nozzle arrays use nozzles having an exclusive (complementary) relationship for the nozzles used in the foregoing column, i.e., the nozzle having a relationship contrary to the above, respectively. The nozzles used in the two nozzle arrays are changed alternately for following columns to distribute the dot data to the two nozzle arrays.

A configuration which completes printing by multiple scanning for one ink color using one nozzle array is known as other configurations of the thinned printing which achieves printing in high resolution and at high-speed. For example, when printing an image having the resolution of 1200 dpi in a scanning direction is completed by two scans, odd-numbered columns are printed in a first scan and even-numbered columns are printed in a second scan. That is, in each scan, columns are printed alternately, i.e. by ejecting ink once at the interval equivalent to 600 dpi (this method is also hereinafter referred to as column thinning). Accordingly, when ejecting ink at frequency at the time that an image having the resolution of 1200 dpi is printed, it is possible to print at a twice scanning speed compared with the case where the image having the resolution of 1200 dpi is printed by one scanning using one nozzle array, similarly to the above. As a result, even when completing printing by two scans, it is possible to print the image having the resolution of 1200 dpi without reducing the whole printing speed. In particular, this method is effective when applying this method to multi-pass printing which completes printing of a predetermined area of a print medium by plural scans between which a conveyance of the print medium is intervened. That is, this multi-pass printing allows a degradation of image quality due to variation in ejecting characteristics between a plurality of nozzles which compose a nozzle array to be reduced as well as the a decrease of the printing speed due to the multiple scanning to be prevented.

Data distribution to each nozzle array at the time of executing column thinning mentioned above is performed as follows. First of all, it is divided into dot data of each of multiple scans by mask processing. Then, the column thinning mentioned above is performed for every scan. More specifically, dot data of every n−1 columns (where n is the number of nozzle arrays) is assigned for each nozzle array.

Generally, if the printing speed is increased, a problem of image quality deterioration due to combining ink together before ink permeation of ink to a print medium will be occurred easily. More specifically, the speeding up of printing increases the quantity of the ink applied to the print medium per unit time. In this case, even if some of printing medium can finally absorb all the ink applied, the ink droplets, which have not been absorbed yet on the surface of the print medium at midway of printing because the absorbing ability of the print medium does not correspond to the applying speed of inks, may contact mutually. Then, the ink which combined together by this contact and became comparatively large is conspicuous in an image finally obtained, and thus image quality may be degraded.

For example, inks are ejected at a comparatively short time difference in the same scan from each nozzle array which ejects the ink of a different color in speed printing. Then, each ink, in the case of being applied to the same pixel or adjacent pixels, attracts each other with mutual surface tension and two (or not less than two) large lumps (hereinafter, also referred to as grain) of the ink may be formed. Moreover, even when printing using ink of one color, the inks are similarly applied to the same pixel or adjacent pixels in the same scanning to sometimes cause combining of the inks. When a relative ink absorption ability of the print medium is inferior, the inks applied at different scans may combine together, and the grain may be caused. If such grain is formed once, the ink given to the adjacent position next thereto is easy to be drawn to the grain. That is, the grain occurred at first becomes a nucleus and grows up gradually, and soon a large grain is formed. Then, an image injurious effect, so-called beading, is caused due to such a grain itself existing or existing in the condition that the grains are scattered irregularly.

In order to solve such a problem, Japanese Patent Laid-Open No. 2008-265354 discloses that dot data is generated so that the dots to be printed are dispersed to be arranged. Then, the dots are dispersed to be arranged, thereby reducing a possibility that the ink which forms the dots would combine together on a print medium, and then the occurrence of the above grain is prevented. Specifically, when binary data (dot data) is generated by performing error diffusion processing for multi-valued image data, in accordance with the result of the error diffusion processing for generating the dot data of a certain color, the multi-valued image data of other colors is corrected, for example. This correction allows the multi valued data of other colors corresponding to the pixel on which the dot data of the above-mentioned certain color are arranged to have a value for which dot data are not generated by the error diffusion processing for this multi-valued data. As a result, the dot arrangement which is a result of the error diffusion processing of the corrected multi-valued image data becomes a dispersed arrangement which does not adjacent to the dot data of the above-mentioned certain color.

However, if the method disclosed in Japanese Patent Laid-Open No. 2008-265354 is attempted to be applied to the thinned printing mentioned above as it is, the thinned printing cannot be performed effectively. For example, as for the thinned printing using a plurality of nozzle arrays, the pattern of the pixel printed by each nozzle array is previously determined as described above. Accordingly, a disagreement may be caused between the pixel arrangement in this pattern and the pixels by which the dot is arranged by being settled in the error diffusion processing disclosed in Japanese Patent Laid-Open No. 2008-265354. In other words, the dot arrangement by the error diffusion processing disclosed in Japanese Patent Laid-Open No. 2008-265354 is subject to the limitation of the above-mentioned pixel pattern. In the case of the column thinning which is another configuration of the thinned printing, the dot arrangement by the error diffusion processing disclosed in Japanese Patent Laid-Open No. 2008-265354 is subject to the limitation by the pattern of the column which prints for every scanning.

### SUMMARY OF THE INVENTION

The object of the present invention is to provide an image data generating apparatus, a printing apparatus, and an image data generation method which make it possible to perform thinned printing without spoiling the dot printing pattern when the above-mentioned error diffusion processing is applied to a thinned printing, and to suppress the occurrence of grain.

In a first aspect of the present invention, there is provided an image data generating apparatus comprising: a dividing unit configured to divide multi-valued image data to be printed on a unit area of a print medium into a plurality of multi-valued data including a first multi-valued data and a second multi-valued data; and a generating unit configured to generate binary data indicating printing or non-printing for each of pixels of the unit area, according to the plurality of multi-valued data and a plurality of arrangement permitting data that determine whether arrangement of data indicating printing is permitted in each of pixels of the unit area, wherein an arrangement of arrangement permitting data determining that the arrangement of data indicating printing is permitted, which is used for the first multi-valued data by said generating unit, is different from an arrangement of arrangement permitting data determining that the arrangement of data indicating printing is permitted, which is used for the second multi-valued data by said generating unit.

In a second aspect of the present invention, there is provided a printing apparatus that prints an image by a relative scan of a printing head provided with a plurality of nozzle arrays and a print medium, said apparatus comprising: a dividing unit configured to divide multi-valued image data to be printed on a unit area of the print medium into a plurality of multi-valued data including a first multi-valued data and a second multi-valued data; a generating unit configured to generate binary data indicating printing or non-printing for each of pixels of the unit area, according to the plurality of multi-valued data and a plurality of arrangement permitting data that determine whether arrangement of data indicating printing is permitted in each of pixels of the unit area, and a print control unit configured to control printing to the unit area based on the first multi-valued data and printing to the unit area based on the second multi-valued data, wherein an arrangement of arrangement permitting data determining that the arrangement of data indicating printing is permitted, which is used for the first multi-valued data by said generating unit, is different from an arrangement of arrangement permitting data determining that the arrangement of data indicating printing is permitted, which is used for the second multi-valued data by said generating unit.

In a third aspect of the present invention, there is provided an image data generating method comprising: a dividing step of dividing multi-valued image data to be printed on a unit area of a print medium into a plurality of multi-valued data including a first multi-valued data and a second multi-valued data; and a generating step of generating binary data indicating printing or non-printing for each of pixels of the unit area, according to the plurality of multi-valued data and a plurality of arrangement permitting data that determine whether arrangement of data indicating printing is permitted in each of pixels of the unit area, wherein an arrangement of arrangement permitting data determining that the arrangement of data indicating printing is permitted, which is used for the first multi-valued data in said generating step, is different from an arrangement of arrangement permitting data determining that the arrangement of data indicating printing is permitted, which is used for the second multi-valued data in said generating step.

According to the above configuration, when the error diffusion processing is applied to the thinned printing, the thinned printing can be performed without spoiling the dot printing pattern of the thinned printing. Moreover, it is simultaneously possible to suppress the occurrence of grain by the dispersed dot arrangement by the above-mentioned error diffusion processing.

Further features of the present invention will become apparent from the following description of exemplary embodiments (with reference to the attached drawings).

### BRIEF DESCRIPTION OF THE DRAWINGS

FIG. 1 is a schematic diagram showing two nozzle arrays and a division pattern for assigning dot data to these nozzle arrays according to one embodiment of the present invention;

FIG. 2 is a perspective view showing an ink-jet printing apparatus according to one embodiment of the present invention;

FIG. 3 is a block diagram mainly showing a configuration of hardware and software of a personal computer as an image processing apparatus according to one embodiment of the present invention;

FIG. 4 is a diagram showing the relationship of a printing head and a print medium in the case of performing two-pass printing;

FIG. 5A and FIG. 5B are diagrams for explaining the case where multi-pass printing of two passes is performed using C ink, according to one embodiment of the present invention;

FIG. 6 is a flow chart showing a procedure of image processing according to a first embodiment of the present invention;

FIG. 7 is a diagram for explaining a concept of a pass division and binarization processing shown in FIG. 6;

FIGS. 8A-8E are diagrams for explaining the binarization processing shown in FIG. 7 according to the contents of data;

FIGS. 9A-9C are schematic diagrams showing dot data assigned to two nozzle arrays according to a comparative example of an embodiment of the present invention;

FIGS. 10A and 10B are schematic diagrams showing the case where the dot data assigned to two nozzle arrays do not shift and where the dot data shifts, according to the comparative example;

FIG. 11A and FIG. 11B are results of the binarization processing shown in FIG. 7 and diagrams showing a plane dot arrangement of a first pass of cyan nozzle arrays A and B;

FIG. 12A is a diagram showing a dot arrangement of the logical addition between the first pass of the cyan nozzle array A shown in FIG. 11A and the first pass of the cyan nozzle array B shown in FIG. 11B; FIG. 12B is a result of the binarization processing shown in FIG. 7 and a diagram showing a plane dot arrangement of the cyan nozzle array B of the second pass; FIG. 12C is a diagram showing a dot arrangement of the logical addition between the first pass of the cyan nozzle array A shown in FIG. 11A, the first pass of the cyan nozzle array B shown in FIG. 11B, and the second pass of the cyan nozzle array B shown in FIG. 12B; FIG. 12D is a result of the binarization processing shown in FIG. 7 and a diagram showing a plane dot arrangement of the second pass of the cyan nozzle array A; and FIG. 12E is a diagram showing a dot arrangement of the logical addition between the first pass of the cyan nozzle array A shown in FIG. 11A, the first pass of the cyan nozzle array B shown in FIG. 11B, the second pass of the cyan nozzle array B shown in FIG. 12B, and the second pass of the cyan nozzle array A shown in FIG. 12D;

FIG. 13 is a diagram for explaining a concept of a pass division and binarization processing shown in FIG. 6 according the second embodiment;

FIG. 14A is a result of the binarization processing shown in FIG. 13 and a diagram showing a dot arrangement of the first pass of the cyan nozzle array A; FIG. 14B is a result of the binarization processing shown in FIG. 13 and a diagram showing a dot arrangement of the first pass of the cyan nozzle array B; and FIG. 14C is a diagram showing a dot arrangement of the logical addition between the first pass of the cyan nozzle array shown in of FIG. 14A and the first pass of the cyan nozzle array B shown in FIG. 14B;

FIG. 15A is a result of the binarization processing shown in FIG. 13 and a diagram showing a dot arrangement of the second pass of the cyan nozzle array B; FIG. 15B is a diagram showing a dot arrangement of the logical addition between the first pass of the cyan nozzle array A shown in FIG. 14A, the first pass of the cyan nozzle array B shown in FIG. 14B, and the second pass of the cyan nozzle array A shown in FIG. 15A; FIG. 15C is a result of the binarization processing shown in FIG. 13 and a diagram showing a dot arrangement of the second pass of the cyan nozzle array B; and FIG. 15D is a diagram showing a dot arrangement of the logical addition between the first pass of the cyan nozzle array A shown in FIG. 14A, the first pass of the cyan nozzle array B shown in FIG. 14B, the second pass of the cyan nozzle array A shown in FIG. 15A, and the second pass of the cyan nozzle array B shown in FIG. 15C;

FIG. 16 is a schematic diagram showing nozzle arrays and a division pattern for assigning dot data to these nozzle arrays according to a third embodiment of the present invention;

FIG. 17 is a flow chart showing a procedure of image processing according to the third embodiment;

FIG. 18 is a diagram for explaining a concept of a column division and binarization processing shown in FIG. 17 according the third embodiment; and

FIGS. 19A-19I are diagrams for explaining the binarization processing shown in FIG. 18 according to the contents of data.

### DESCRIPTION OF THE EMBODIMENTS

Hereinafter, the embodiments of the present invention will be described in detail, with reference to drawings.

### First Embodiment

A first embodiment of the present invention relates to a configuration that a printing head used in an ink-jet printing apparatus includes two nozzle arrays for ejecting each ink of cyan (C), magenta (M), and yellow (Y), thereby performing a thinned printing. Moreover, the thinned printing is performed by a multi-pass printing method which completes printing by two times of scanning (two passes). In addition, the error diffusion processing suited for the thinned printing generates binary data (also referred to as dot data or ejection data) in the thinned printing by using the multi-pass printing method of the two passes. Note that, in the following explanation, a set of image data (binary data, multi-valued data) distinguished by the ink colors and scans is referred to as “plane”.

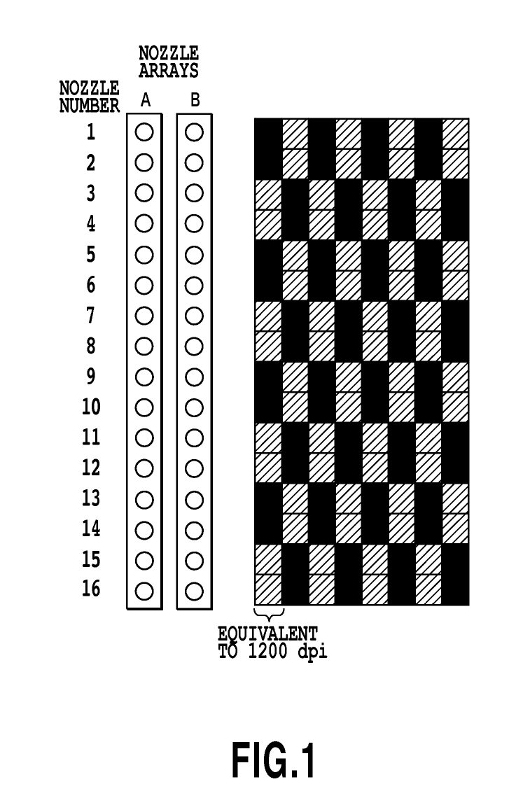

FIG. 1 is a diagram showing an arrangement of nozzle arrays which eject ink of one certain color and a division pattern for the thinned printing according to this embodiment. As shown in FIG. 1, in this embodiment, printing is performed by using two nozzle arrays A and B for one ink color. Although each nozzle array arranges 512 nozzles having the density of 1200 dpi, it is shown in FIG. 1 as an example that 16 nozzles are arranged, respectively because of simplification of illustration and explanation. In both two nozzle arrays A and B, the position in the direction of nozzle arrangement of each nozzle is the same position.

The division pattern shown in FIG. 1 shows whether the printing of each pixel is performed using which nozzle of nozzle arrays A and B, and the pixel indicated by black color is printed by using the nozzle of the nozzle array A and the pixel shown with hatched line is printed by using the nozzle array B. Moreover, the pixel indicated by black color and the pixel shown with hatched lie have the relationship of exclusion mutually.

As described later, in the error diffusion processing according to the generation of dot data of this embodiment, the dot arrangement as a result of the error diffusion processing is subject to the limitation of the nozzle assignment for every pixel of the division pattern. For example, in the generation of the dot data assigned to the nozzle array A, when the pixel in which a dot is arranged as a result of the error diffusion processing is a pixel to which the nozzle array B is assigned in the above-mentioned pattern, the dot data are not generated. More specifically, as shown in FIG. 1, the patterns of nozzle arrays A and B are arrangement permitting data which shows positions which permit arranging dots so that the assignment patterns for nozzle arrays A and B have the mutual complementary relationship.

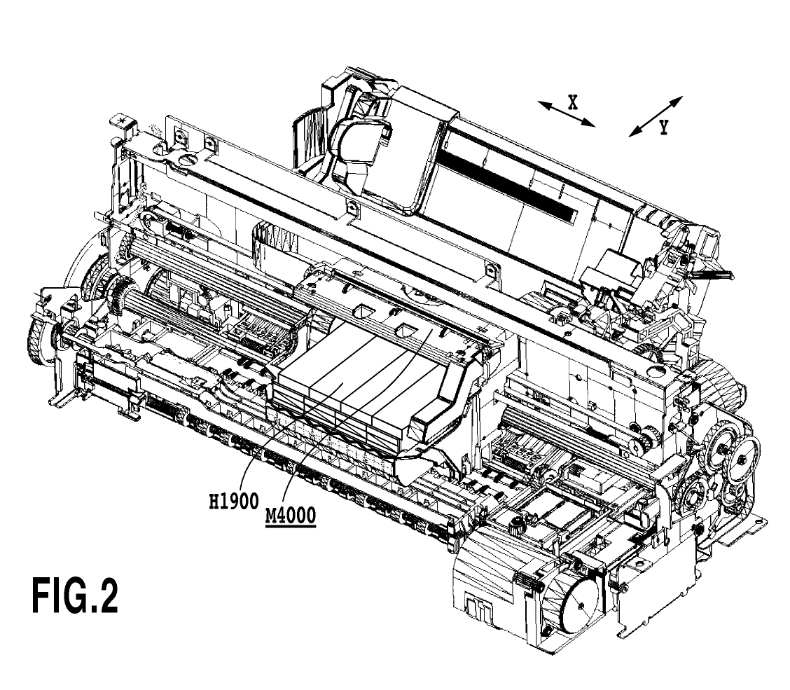

FIG. 2 is a perspective view showing an ink-jet printer according to one embodiment of the present invention. The carriage M4000 mounts a printing head that ejects each ink of cyan (C), magenta (M), yellow (Y), black (K) and an ink tank H1900 which supplies the ink corresponding thereto, and can be moved in the direction of X shown in FIG. 2 (main scanning direction). Each printing head of C, M, Y, and K is provided with two nozzle arrays, respectively, as mentioned above with FIG. 1, and the division pattern corresponding to the two nozzle arrays is defined. The ink is ejected from the nozzle of the nozzle arrays of each color at the predetermined timing during the scanning of the printing head by moving of the carriage based on the dot data generated as mentioned below. When completing of such one main scanning of the printing head, only the predetermined amount of the print medium is conveyed in the direction of Y shown in FIG. 2 (sub-scanning direction). An image is formed one after another by repeating the printing with the above main scanning direction and a sub-scanning direction alternately. The arrangement density of ejection ports in each nozzle array mentioned above is 1200 dpi as mentioned above, and 4.0 pico-liter of ink is ejected from each ejection port.

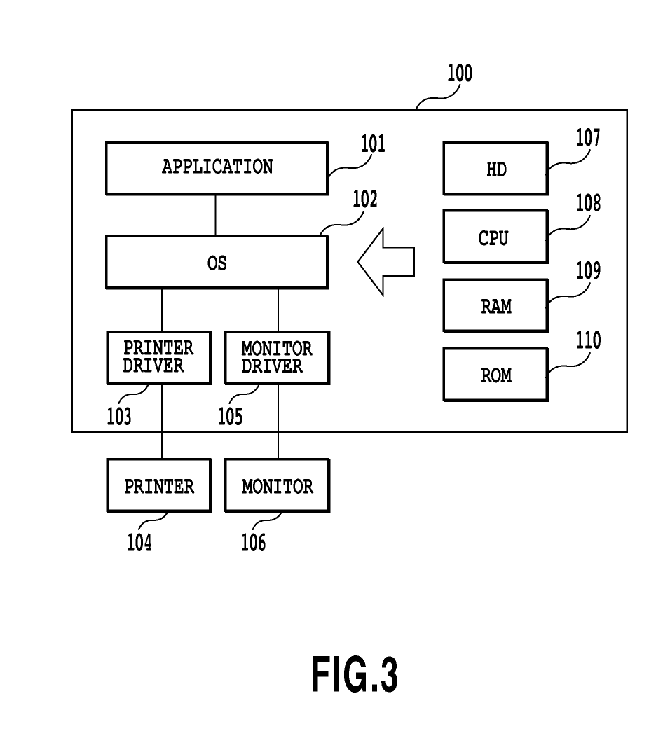

FIG. 3 is a block diagram mainly showing a configuration of the hardware and software of a personal computer (hereinafter, simply referred to as PC) as an image processing apparatus (image data generating apparatus) according to one embodiment of the present invention. In FIG. 3, the PC 100 which is a host computer operates each software of application software 101, a printer driver 103, and a monitor driver 105 with an operating system (OS) 102. The application software 101 executes processing regarding a word processor, a spreadsheet, an. Internet browser, etc. The monitor driver 109 executes processing of creating image data which is displayed on a monitor 106.

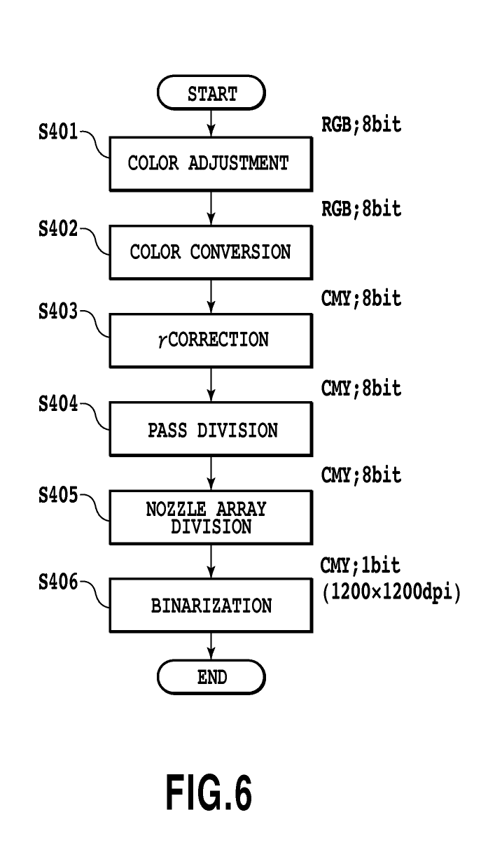

The printer driver 103 executes image processing of image data etc. issued from the application software 101 to the OS 102, and generates binary ejection data of finally used for a printer 104. For more details, binary image data (dot data) of the cyan, magenta, and yellow used for the printer 104 is generated from multi-valued image data of cyan, magenta, and yellow by executing image processing later described in FIG. 6, etc. Thus, the generated binary image data is transferred to the printer 104.

The host computer 100 is provided with CPU 108, a hard disk drive (HD) 107, RAM 109, ROM 110, etc. as various kinds of hardware for operating the above software. That is, the CPU 108 executes the processing according to the above-mentioned software program stored in the hard disk 107 and the ROM 110, and the RAM 109 is used as a work area in the case of executing the processing.

The printer 104 includes CPU, the memory, etc. (not shown). The binary image data transferred from the host computer 100 is stored in the memory of the printer 104. Then, the binary image data stored in the memory is read and sent to a drive circuit of the printing head under control of the CPU of the printer. Then, the drive circuit drives a printing element of the printing head based on the sent binary image data to be ejected the ink from the ejection port.

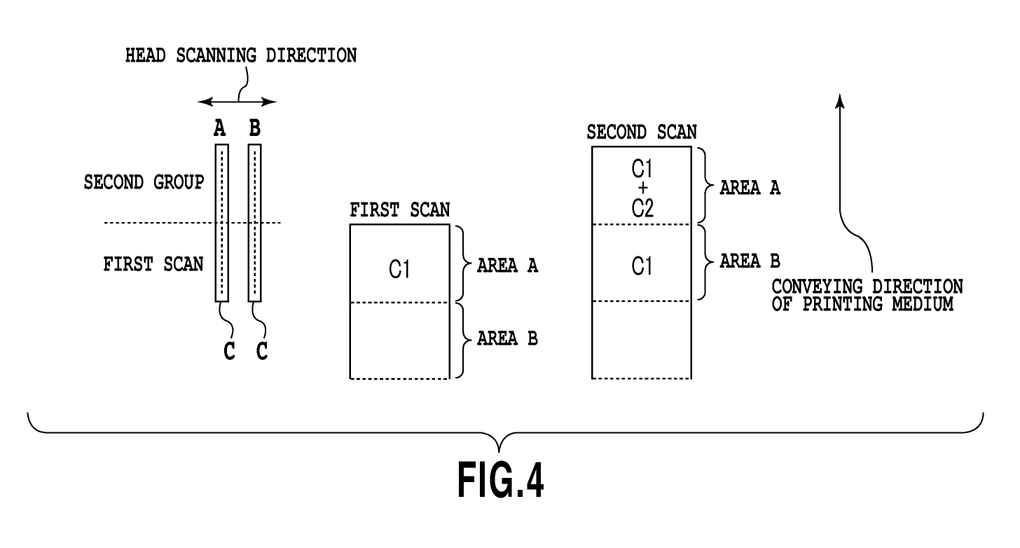

FIG. 4 is a diagram showing schematically multi-pass printing of two passes which can be executed in the printer (the ink-jet printing apparatus) 104 of this embodiment explained above. Note that, FIG. 4 shows the case where two-pass printing is performed with one color of cyan, because of simplification of illustration and explanation. As explained below, in the case of the two-pass printing, the image to be printed on a unit area of the print medium is completed by two times of scanning of the printing head.

Two nozzle arrays A and B are divided into two groups of a first group and a second group, respectively, and, thereby, 256 nozzles are included in each group. The printing head including the nozzle arrays A and B is scanned in a direction substantially orthogonal to the direction of nozzle arrangement (“head scanning direction” shown by the arrow in FIG. 4; main scanning direction) and ejects the ink to the unit areas A, B of the print medium. In this example, the ink of C is ejected for unit area A based on the binary image data (C1) for nozzle arrays A and B of C. Moreover, the print medium is conveyed for every width of one group (herein, 256 pixels same as the width of the unit area) in the direction orthogonal to the scanning direction (“print medium conveying direction” shown by the arrow of FIG. 4) whenever the scanning is completed. Accordingly, as for the unit area A of the size corresponding to the width of each group of the print medium, the image (C1+C2) is completed by two scanning.

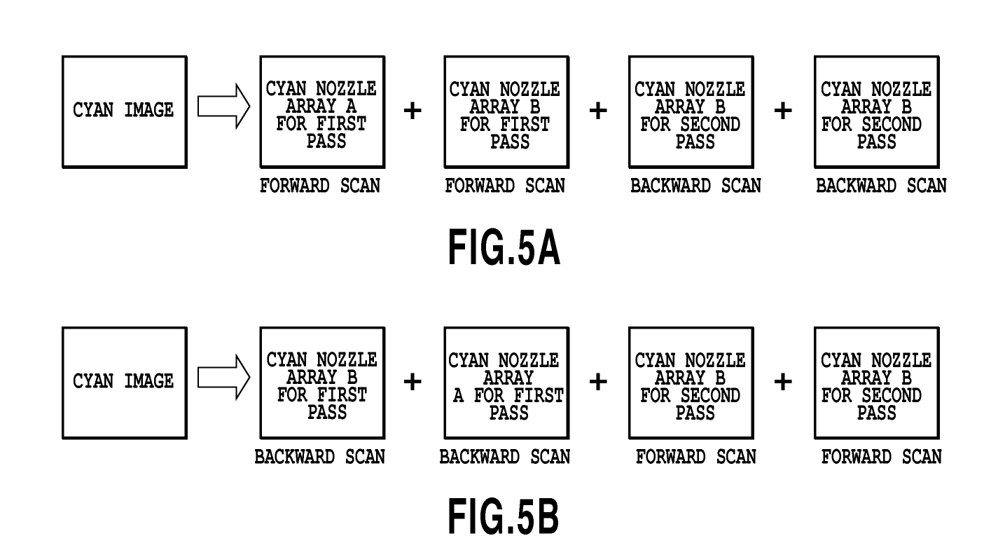

FIG. 5A and FIG. 5B is diagrams for explaining the order of printing for the unit area in the case of performing multi-pass printing of two passes using C ink explained in FIG. 4.

FIG. 5A shows a manner that an image of an area printed in the order of forward scan to backward scan (area A of FIG. 4) is completed. In forward scan (first pass) which is first scan, a cyan image is printed in the order of an image by the nozzle array A to an image by the nozzle array B at first, based on each dot data for cyan nozzle arrays A and B generated by data division processing and binarization processing described later in FIG. 6. In backward scan of the second pass after conveying a predetermined amount of the print medium, printing is performed on the image printed before then in the order of the nozzle array B to the nozzle array A similarly, based on each dot data for cyan nozzle arrays A and B generated by the data division processing described later.

On the other hand, FIG. 55 shows a manner that an image of an area printed in the order of backward scan to forward scan (area B of FIG. 4) is completed. In backward scan (first pass) which is first scan, a cyan image is printed in the order of an image by the nozzle array B to an image by the nozzle array A, based on each dot data for cyan nozzle arrays A and B generated by data division processing and binarization processing described later, similarly. In forward scan (second pass) which is second scan after conveying a predetermined amount of the print medium, printing is performed on the image printed before then in the order of an image by the nozzle array A to an image by the nozzle array B, based on each dot data for cyan nozzle arrays A and B generated in the similar manner.

In this embodiment, the dot data in which the dot arrangement obtained by superimposing the plane of each dot data for nozzle arrays A and B used for the printing in the above-mentioned forward/backward scan is dispersed excellent, is generated. At the same time, the dot data whose dot arrangement satisfies division patterns that is shown in FIG. 1 and assigned to the nozzle arrays A and B is generated. The dispersed dot arrangement allows occurrence of a low-frequency component which does not exist in the multi-valued image data before quantization to be reduced as much as possible. Herein, the low-frequency component which does not exist in the data before quantization means the component which is occurred by interference of a pattern of image data and a mask pattern in a division of the image using the mask pattern performed conventionally, and the like. According to this embodiment, the binary data of each of the above described planes is generated so that the low-frequency component in each of dot distributions in superimposing of planes of “the cyan nozzle array A of the first pass+the cyan nozzle array B of the first pass”, “the cyan nozzle array A of the first pass+the cyan nozzle array B of the first pass+the cyan nozzle array B of the second pass”, and “the cyan nozzle array A of the first pass+the cyan nozzle array B of the first pass+the cyan nozzle array B of the second pass+the cyan nozzle array A of the second pass”, which are obtained by superimposing the planes of the cyan nozzle array A of the first pass, the cyan nozzle array A of the first pass, the cyan nozzle array B of the first pass, the cyan nozzle array B of the second pass, and the cyan nozzle array A of the second pass in this order which is an ejecting order of the nozzle arrays in each scan (hereinafter, referred to as pass) in which printing is performed in the order shown in FIG. 5A, is reduced. In particular, the binary data whose dot arrangement has less low frequency components is generated in the dot distribution in the intermediate superimposing of other planes as well as in the dot distribution of “the cyan nozzle array A of the first pass+the cyan nozzle array B of the first pass+the cyan nozzle array B of the second pass+the cyan nozzle array A of the second pass” which is the final superimposing. Moreover, as for the area printed in a sequence shown in FIG. 5B, the data is generated so that the dot distributions of a similar intermediate image obtained by superimposing the planes in the order of the nozzle array B of the first pass, the cyan nozzle array A of the first pass, the cyan nozzle array A of the second pass, the cyan nozzle array B of the second pass, respectively, have the above-mentioned high dispersibility. In addition, the pixel number of each plane made into a processing object in the embodiment is 256 pixels (nozzle arranging direction)×pixel number equivalent to printing width (in main scanning direction). Furthermore, it is clear also from the following explanation that the present invention is similarly applicable to the case where the ink of 4 colors in which added black (K) is used, and the case where light ink having low concentration and special color ink, such as, red, blue, and green are further added to be used.

FIG. 6 is a flow chart showing a procedure of image processing according to the first embodiment of the present invention. This processing is mainly executed by the printer driver 103 in the host device 100 shown in FIG. 3.

First, at Step S401, color adjustment processing such as input gamma correction is performed about RGB data of image obtained by an application or the like. Next, at Step S402, for the image data of RGB, conversion is performed from a color gamut of R, G, and B into a color gamut of the color component C, M, and Y of the ink used for the printer, and color component data C, M, and Y expressing the color in the converted color gamut are generated. These processing is performed by using a look-up table with use of interpolating calculation together. As a result of these processing, each eight bit image data of R, G, and B is converted into each eight bit data of C, M, and Y (multi-valued image data). Next, at Step S403, output gamma correction is performed to adjust input/output gradation characteristics of the printing head used for the printer 104.

Next, at Step S404, in advance of binarization processing, pass division is performed in a stage of multi-valued image data. Furthermore, after performing the pass division, division into data of each of two nozzle arrays is performed at Step S405. More specifically, the pixel values of each 8 bit data of C, M, and Y (multi-valued image data) are set to one half, and, each of the data is set to each data for two scanning of the multi-pass printing of two passes. Furthermore, the pixel values of 8 bit data set to one half every passes obtained as mentioned above are set to one half, and each thereof is set to each data of nozzle arrays A and B.

At Step S906, binarization processing (error diffusion processing) is performed after the above processing, under conditions or limitations that the dot data to be printed by using a nozzle of the nozzle array can be disposed on only the pixel shown with the division pattern of every nozzle arrays A and B shown in FIG. 1. That is, the error diffusion processing is performed for every nozzle array under the conditions where the dot can be disposed to all the pixels using both nozzle arrays A and B in one scanning.

The details of the pass division processing of Step S404, the nozzle array division processing of Step S905, and the processing for performing the binarization of the divided multi-valued image data to generate the dot data of Step S406 explained above will be explained below. Hereinafter, processing of only cyan will be explained in order to simplify explanation.

In the pass division of Step S404, the cyan 8-bit multi-valued image data is divided into two parts. In 8 bit data expressed by 0 to 255 in this embodiment, it means that density of “255” is the highest one and the density of “0” is the lowest one. Therefore, the density of the half of the density of “100” is “50”. For example, when 8 bit data is C=200, the data value “200” is simply set to one half and is set as C=100 so that the density of the first pass and second pass becomes substantially uniform. Thus, 8 bit data is obtained about each two plane of the first pass of cyan and the second pass of cyan. Herein, although the value of multi-valued image data is equally divided into two, an aspect in which the image data is divided unequally may be allowed rather than equal division which may not be always necessary. For example, three fifths of pixel values may be distributed to a first pass, and two fifths of pixel values may be distributed to a second pass. In this case, C=120 equivalent to three fifths of 0=200 becomes the multi-valued data of the first pass, and C=80 equivalent to two fifths becomes the multi-valued data of the second pass.

In nozzle array division of Step S405, the cyan 8-bit multi-valued image data for every pass obtained by dividing into two passes as mentioned above is divided into two. For example, when the multi-valued data of the first pass of cyan and the second pass of cyan are C=100, respectively, C=50 of half data is applied for the nozzle array A and the nozzle array B, respectively. Thus, 8 bit data of 4 planes of the cyan nozzle array A of the first pass, the cyan nozzle array B of the first pass, the cyan nozzle array A of the second pass, and the cyan nozzle array B of the second pass are obtained.

In Step S406, the binarization processing is performed by the error diffusion method according to this embodiment for each 4 above-mentioned plane. When performing the error diffusion one after another to the multi-valued image data (plane) corresponding to each scanning and each nozzle array, this binarization processing performs following error diffusion processing based on the result of the error diffusion processing performed in advance. Also, at the same time, the error diffusion processing is performed in consideration of the pixel (position) which permits arrangement of the dot for every nozzle array using arrangement permitting data, as mentioned above regarding FIG. 1.

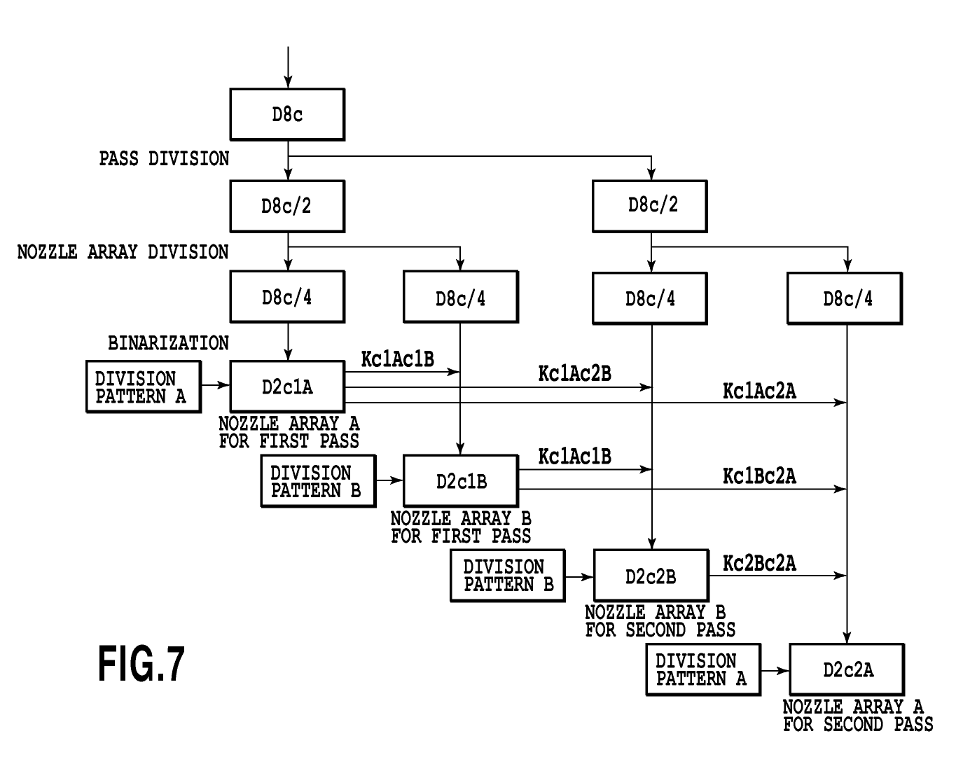

FIG. 7 is a diagram showing the details of the pass division of Step S404, the nozzle array division of Step S406, and the binarization processing of Step S405. In a first embodiment of the present invention, when generating the dot data for two passes for each of nozzle arrays of cyan, for example, the dot data of a total of four planes, the binarization processing is sequentially performed by one plane in an order according to which dots are formed in the scanning of the printing head, by using the error diffusion method. In this case, the pixel (position) in which dot arrangement is possible in processing of each plane is set up as a division pattern for each of nozzle arrays as shown in FIG. 1. That is, the dot arrangement as a result of performing the error diffusion will be limited by a plurality of the arrangement permitting data for each of the above-mentioned nozzle arrays. At the same time, the result of the binarization processing of the already generated plane is made to be reflected to the binarization processing of the plane to be generated after this. Note that, the binarization processing shown in FIG. 7 shows the processing which followed in order of formation of the dot shown in FIG. 5A. The size of each plane generated by the binarization processing of this embodiment is the size of the main scanning direction (horizontal direction)×the nozzle arranging direction (lengthwise direction)=printing width×256 pixels, which is a unit area. As for the image data to be printed, the data division and the binarization processing for the whole image data are performed by performing the data division and the binarization processing by making the plane of this size into a unit. In the following explanation, although explained as processing for one pixel data because of simplification of explanation, sequential processing is actually performed for each of pixels in the plane. In particular, although the error diffusion method is used as the method of the binarization as mentioned below in this embodiment, this processing is performed by moving the pixel of a processing object one after another as is well known.

In FIG. 7, multi-valued data D8c of 8 bits of cyan per pixel obtained at step S403 is divided into data D8c/2 whose pixel value is set as ½ by the pass division. Further, by the nozzle array division, the pixel value is divided into ½, i.e., into D8c/4 which is ¼ of the initial pixel value. The multi-valued data divided in this manner becomes cyan multi-valued data for nozzle array A of the first pass, cyan multi-valued data for the nozzle array B of the first pass, cyan multi-valued data for the nozzle array A of the second pass, and cyan multi-valued data for the nozzle array B of the second pass, respectively.

In the next binarization processing, first, the error diffusion processing is performed for the cyan multi-valued data D8c/4 of the nozzle array A of the first pass, and then cyan binary data D2c1A for the nozzle array of the first pass is obtained. In the case of this error diffusion processing, it is allowed to arrange the dot (binary) data to the arrangement permitted position (pixel) shown by the division pattern of the nozzle array A shown in FIG. 1. Next, the binarization processing is performed for the cyan multi-valued data D8c/4 of the nozzle array B of the first pass. At this time, in this embodiment, correction which adds the term of Kc1Ac1B (D8c/4−D2c1A) is performed for the cyan multi-valued data D8c/4 of the nozzle array B of the first pass. Here, when an area of a processing range is considered widely, as for the correction term Kc1Ac1B (D8c/4−D2c1A), the average approaches 0. As for the binary data based on error diffusion processing, this is because an average density in a neighborhood before binarization and after binarization does not change by a density preservation function, which is characteristics of the error diffusion processing. Therefore, the correction term which is made by being multiplied by Kc1Ac1B is also set to 0 by obtaining (D8c/4−D2c1A) in a sufficiently wide processing area. Then, the error diffusion processing is performed for the corrected multi-valued data [D8c/4+Kc1Ac1B (D8c/4−D2c1A)], and then cyan binary data D2c1B for the nozzle array B of the first pass is obtained. In this processing, in the error diffusion processing, the result of the binary data for the first passes of the nozzle arrayAperformed previously is made to be reflected, and it is allowed to arrange the binary data only to the arrangement permitted position shown by the division pattern of the nozzle array B.

Thus, according to this embodiment, the result of the error diffusion processing performed previously is reflected in the following error diffusion processing, and the limitation is imposed on the arrangement of the dot as a result of each the error diffusion processing. In addition, in the above-mentioned correction term, D8c/4 is the cyan multi-valued data as mentioned above, and D2c1A is a result of the binarization processing. Moreover, Kc1Ac1B is a weighting factor and is defined corresponding to how much relation is given between the planes.

In third generation of the plane of the cyan nozzle array B of the second pass, correction which adds the correction term (Kc1Ac2B(D8c/4−D2c1A)+Kc1Bc2B(D8c/4−D2c1B)) as a result of the first and second error diffusion is performed for the divided multi-valued data D8c/4. Then, the binarization is performed for the corrected multi-valued data [D8c/4+(Kc1Ac2B(D8c/4−D2c1A)+Kc1Bc2B(D8c/4−D2c1B))], and cyan binary data D2c2B of the nozzle array B of the second pass is obtained. In this case, binary data is arranged only at the arrangement permitted position shown by the division pattern of the nozzle array B. Thus, in the generation of the third plane, the correction reflecting the result of the binarization processing of the first and second plane processed till then is performed, and the error diffusion processing is performed for the corrected data. Further, it is allowed to arrange the binary data only to the arrangement permitted position shown by the division pattern of the nozzle array B.

Similarly in subsequent processing, in generation of the fourth plane of the cyan nozzle array A of the second pass, a correction which adds the correction term (Kc1Ac2B(D8c/4−D2c1A)+Kc1Bc2A(D8c/4−D2c1B)+Kc2Bc2A(D8c/4−D2 c2B)) by the result of the first, second and third error diffusion is performed for the multi-valued data D8c/4. Then, the binarization is performed for the corrected multi-valued data [D8c/4+((Kc1Ac2B(D8c/4−D2c1A)+Kc1Bc2A(D8c/4−D2c1B)+Kc2B c2A (D8c/4−D2c2B)))], and then cyan binary data D2c2A of the nozzle array A of the second pass is obtained. In the error diffusion processing in this case, it is allowed to arrange the binary data only to the arrangement permitted position shown by the division pattern of the nozzle array B.

Although the division of the multi-valued data for two passes of cyan is performed by dividing into two equally in the above-mentioned example, the rate of this division may be unequal. For example, the first pass of cyan can be set to D8c/3, and the second pass can also be set to (D8c/3)×2. Of course, the division is similarly performed even in another case other than the two passes, for example, in the case of four passes, and the ratio of density of the second pass and third pass can also be increased for the ratio of density of the first pass and fourth pass. Also, the nozzle array division is performed after performing the pass division regarding the division of the cyan multi-valued data, but division into the ratio of 1/4 can also be performed at once.

The generation of four planes of this embodiment is performed as follows when generalizing as generation of N planes. Note that, since the number of passes and the rate of division are not necessarily unmatched as mentioned above, “D8j” is simply written about the j^{th} divided data, without expressing using “/4” such as the above D8c/4, for example, for the divided data.

The correction term related to the j-th plane generation from the first to the N-th planes is expressed reflecting the result from the first to (j−1)-th binarization processing by the following formula:

K[1][j](D81−D21)+ . . . +K[j−1][j](D8(j−1)−D2(j−1))

Then, the j-th data corrected by adding this correction term is expressed by the following formula:

D2j=D8j+(K[1][j](D81−D21)+ . . . +K[j−1][j](D8(j−1)−D2(j−1))

where K[i] [j] is a weighting factor of the correction term which the i-th data gives to the j-th data. The error diffusion processing is performed for this corrected data, and in the case of each processing, dot data D2j is obtained so as to be arranged to the allowable position limited by the division pattern for each of nozzle arrays.

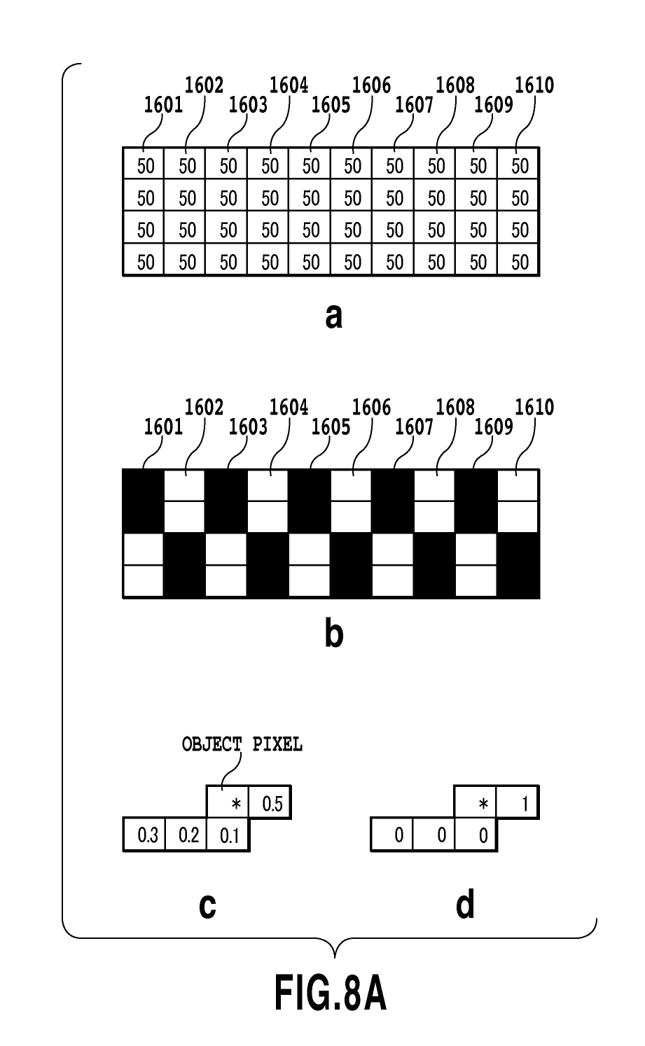

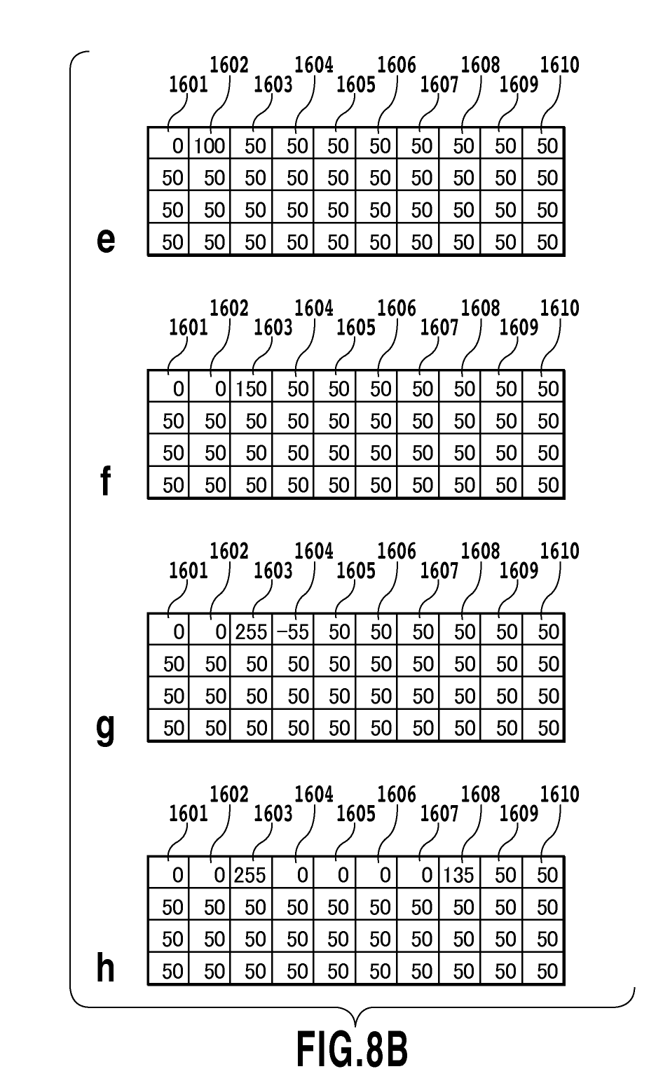

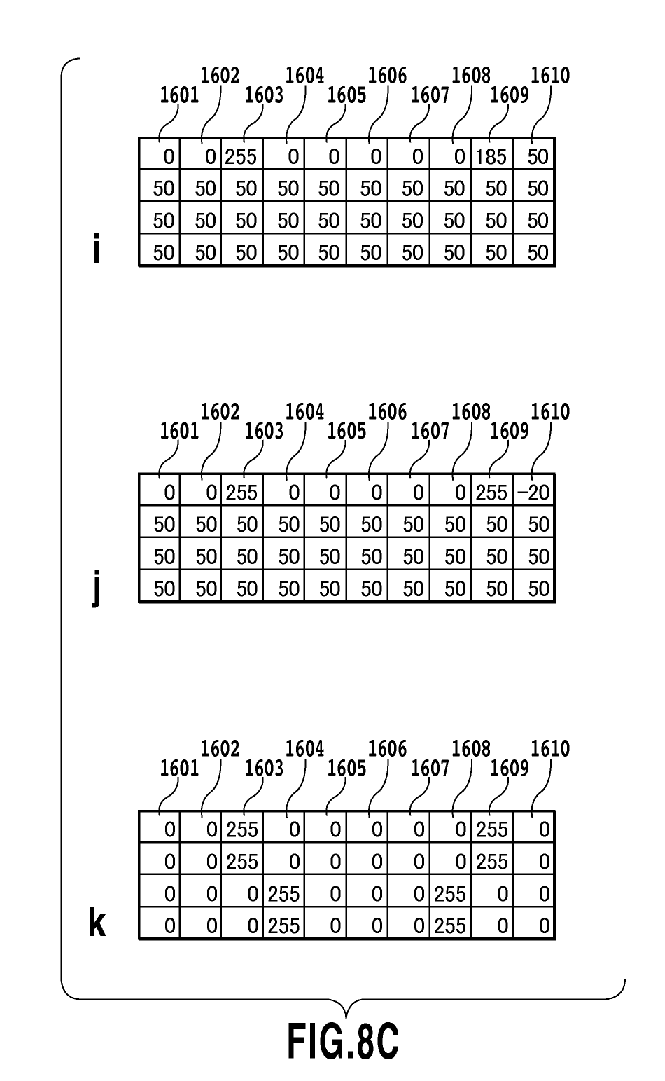

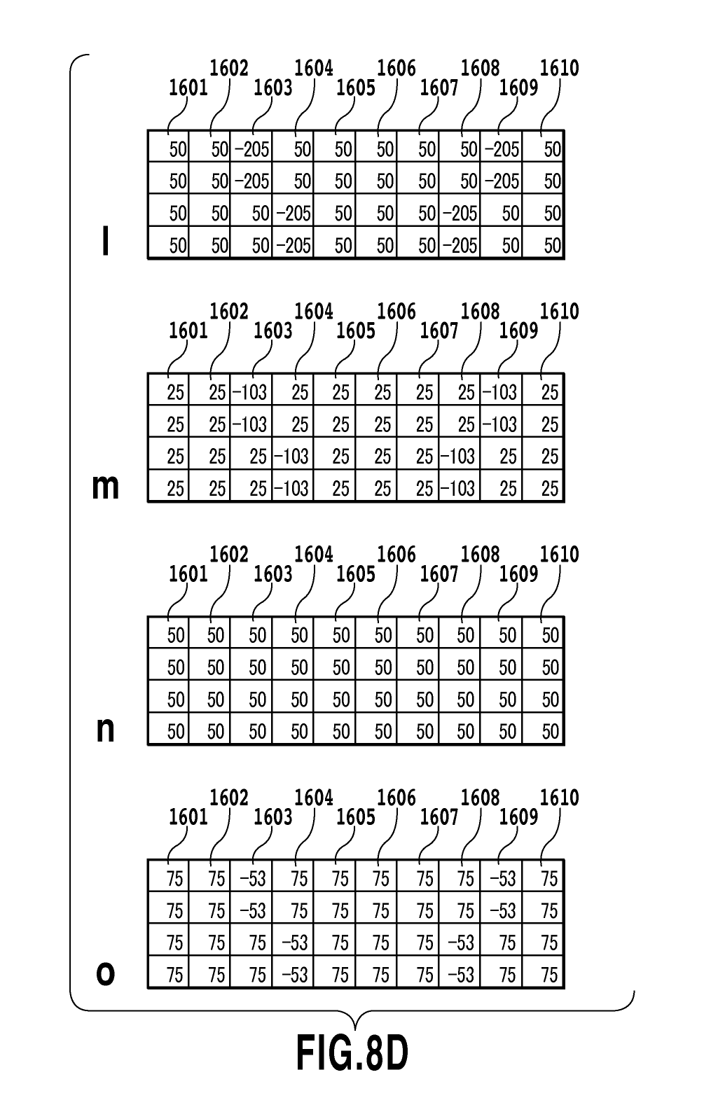

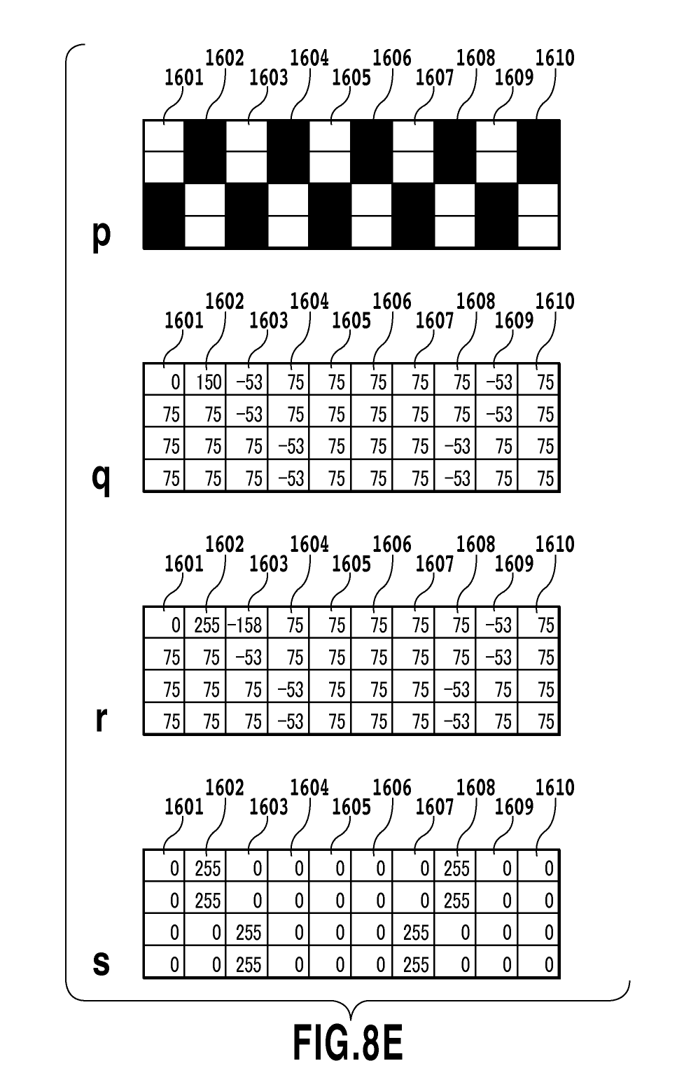

FIGS. 8A to 8E are diagrams for explaining the binarization processing explained in FIG. 7 according to the contents of data. Note that, FIGS. 8A to 8E show the size of the plane as 10 pixels×4 pixels because of simplification of explanation and illustration.

A Partial diagram a of FIG. 8A shows cyan multi-valued data D8c/4 of 8 bits of the nozzle array A of the first pass. A Partial diagram b of FIG. 8A shows the division pattern that indicates the arrangement permitted position of the cyan nozzle array A of the first pass, in which pixel positions indicated by black color in FIG. 8A expresses the arrangement permitted positions. Herein, in order to explain simply, the case where the pixel value of multi-valued image data is 50 is shown. Also, a Partial diagram k of FIG. 8C shows binary data D2c1A obtained by the error diffusion processing for the multi-valued image data D8c/4. Note that, this binary data is binary data having the value of either of “0” or “255” of 8 bits, and the same is true in the following explanation.

Hereinafter, processing for arranging only to the pixel position indicated by black in the division pattern of the nozzle array A shown by the Partial diagram b of FIG. 8A when generating binary data by the error diffusion will be explained in detail.

A Partial diagram c of FIG. 8A is a diagram showing an example of distribution of the diffusion coefficient used by well-known error diffusion processing. As seen from the drawing, it is general to distribute an error by ratios illustrated for 4 pixels of the circumference. In this embodiment, explanation will be given for processing in the case of using a diffusion coefficient in which all the diffusion of error are distributed to pixels on the right as shown in the Partial diagram d of FIG. 8A, because of simplification of illustration and explanation. Also, a threshold value of the binarization is set to be 128.

First, the binarization for a pixel 1601 shown in the Partial diagram a of FIG. 8A is performed. Since the pixel value of the pixel 1601 is 50 and is smaller than the threshold value 128, binary data “0” is arranged at the pixel 1601 as shown in the Partial diagram e of FIG. 8B. At the same time, an error is calculated. By setting the output value to the pixel 1601 to 0, the difference 50 (=50−0) from the gradation value 50 of the pixel 1601 shown in the Partial diagram of FIG. 8A is diffused to a pixel 1602 on the right according to the diffusion coefficient shown in the Partial diagram d of FIG. 8A as an error. Accordingly, the gradation value of the pixel 1602 is updated to 100 by that the error 50 is added to the gradation value of the pixel 1602 and then has a value shown in Partial diagram e of FIG. 88. Next, the binarization for the pixel 1602 shown in Partial diagram e of FIG. 88 is performed. Since the pixel value of the pixel 1602 is 100 and is smaller than the threshold value 128, binary data “0” is arranged at the pixel 1602 as shown in Partial diagram f of FIG. 8B. Similarly, an error is calculated and the difference 100 (=100−0) from the gradation value 100 of the pixel 1602 shown in Partial diagram e of FIG. 8B is diffused to a pixel 1603 as the error. As a result, the error 100 is added to the gradation value of the pixel 1603 so that the gradation value of the pixel 1603 is updated to 150 and then is shown in Partial diagram f of FIG. 8B.

Next, the binarization for the pixel 1603 shown in Partial diagram f of FIG. 8B is performed. Since the pixel value of the pixel 1603 is 150 and is larger than the threshold value 128, the pixel 1603 is made a candidate for a pixel to which binary data “255” is arranged. In this case, in the binarization processing of this embodiment, it is determined whether or not the pixel 1603 is a pixel for which arrangement is permitted according to the division pattern of the nozzle array A shown in Partial diagram b of FIG. 8A. Since the pixel 1603 shown in Partial diagram b of FIG. 8A is permitted (indicated by black), binary data “255” is arranged at the pixel 1603 as shown in Partial diagram g of FIG. 88. Then, an error is calculated. By setting the value of the pixel 1603 into 255, the difference −105 (=150−255) from the original gradation value 150 (Partial diagram f of FIG. 8B) is diffused to a pixel 1604 as an error, and the error −105 is added to the gradation value of the pixel 1604 to be updated to −55 (Partial diagram g of FIG. 8B).

Similarly, the binarization and the diffusion of error is sequentially performed for pixels of from 1604 to 1607, and the gradation value 135 in which the pixel 1608 is updated is obtained (Partial diagram h of FIG. 8B).

Next, the binarization for the pixel 1608 is performed. Since the pixel value of the pixel 1608 is 135 as shown in Partial diagram h of FIG. 8B, and is larger than the threshold value 128, the pixel 1608 is made the candidate for a pixel to which binary data “255” is arranged. Then, it is determined whether or not the pixel 1608 is a pixel for which arrangement is permitted in the division pattern of the nozzle array A shown in Partial diagram b of FIG. 8A. Since arrangement is not permitted for the pixel 1608 as shown in Partial diagram b of FIG. 8A, binary data “0” is arranged at the pixel 1608 shown in Partial diagram of FIG. 8C. As for the error at this time, since the value of the pixel 1608 is set to 0, the difference 135 (=135−0) from the original gradation value 135 is diffused to a pixel 1609 as an error as it is as well as the above-mentioned calculation. As a result, the error 135 is added to the gradation value of the pixel 1609 to be updated to 185 (Partial diagram i of FIG. 8C).

Next, the binarization for the pixel 1609 shown in Partial diagram i of FIG. 8C is performed. Since the pixel value of the pixel 1609 is 185 and is larger than the threshold value 128, the pixel 1609 is made a candidate for a pixel to which binary data “255” is arranged. Then, it determined whether or not the pixel 1609 is a pixel for which arrangement is permitted according to the division pattern of the nozzle array A shown in Partial diagram b of FIG. 8A. Since arrangement is permitted for the pixel 1609 as shown in Partial diagram b of FIG. 8A, binary data “255” is arranged at the pixel 1609 as shown in Partial diagram j of FIG. 8C. Then, an error is calculated. By setting the value of the pixel 1609 into 255, the difference −70 (=185−255) from the original gradation value 185 is diffused to a pixel 1610 as an error, and the error −70 is added to the gradation value of the pixel 1610 to be updated to −20 (Partial diagram j of FIG. 8C).

Similarly for subsequent pixels, the binarization is performed and the binary data shown in Partial diagram k of FIG. 8C with the value “255” arranged only at the pixel position indicated by black in the division pattern of the nozzle array A shown in Partial diagram b of FIG. 8A is generated.

Next, Partial diagram 1 of FIG. 8D shows correction data generated using multi-valued data D8c/4 and binary data D2c1A. Specifically, the result of having subtracted the binary data D2c1A shown in Partial diagram k of FIG. 8C from the multi-valued data D8c/4 shown in Partial diagram a of FIG. 8A is set to the correction data of the multi value. Then, this correction data is added to the multi-valued data D8m/4 of the cyan nozzle array B of the first pass related to the generation of the second plane. In this case, Kc1Ac1B is used as a weighting factor for the correction data. When Kc1Ac1B=1, the correction data is added to the cyan multi-valued data of the nozzle array B of the first pass as it is, and when Kc1Ac1B=0.5, the value of the half of the correction data value is added to the cyan multi-valued data of the nozzle array B of the first pass. Kc1Ac1B=0.5 is set in the example shown in FIG. 8. Partial diagram m of FIG. 8D shows the correction data in this case. Then, by using this correction data shown in Partial diagram m of FIG. 8D, the cyan multi-valued data D8c/4 of the nozzle array B of the first pass shown in Partial diagram n of FIG. 8D is corrected.

Partial diagram o of FIG. 8D shows multi-valued data after this correction, and is expressed as the sum of the data shown in Partial diagram m of FIG. 8D and the data shown in Partial diagram n of FIG. 8D. Next, the case where the error diffusion is performed for multi-valued data shown in Partial diagram o of FIG. 8D will be explained similarly. Partial diagram p of FIG. 8E is a diagram showing positions indicated by a black color in which the arrangement is permitted in the division pattern of the nozzle array B.

First, the binarization for a pixel 1601 shown in Partial diagram o of FIG. 8D is performed. Since the pixel value of the pixel 1601 is 75 and is smaller than the threshold value 128, binary data “0” is arranged at the pixel 1601 as shown in Partial diagram g of FIG. 8E. An error is calculated at this point. By setting the value of the pixel 1601 to 0, the difference 75 (=75-0) from the original gradation value 75 is set to be an error, and is diffused to a pixel 1602 on the right according to the diffusion coefficient shown in Partial diagram d of FIG. 8A. The error 75 is added to the gradation value of the pixel 1602 to be updated to 150 (Partial diagram q of FIG. 8E).

Next, the binarization for the pixel 1602 shown in Partial diagram q of FIG. 8E is performed. Since the pixel value of the pixel 1602 is 150 and is larger than the threshold value 128, the pixel 1602 is made a candidate for a pixel in which binary data “255” is arranged. Then, it determined whether or not the pixel 1602 is a pixel for which the arrangement is permitted according to the division pattern of the nozzle array B shown in Partial diagram p of FIG. 8E. Since the arrangement of the pixel 1602 as shown in Partial diagram p of FIG. 8E is permitted (indicated by black), binary data “255” is arranged at the pixel 1602 as shown in Partial diagram r of FIG. 8E. Then, an error is calculated. By setting the value of the pixel 1602 to be 255, the difference −105 (=150−255) from the original gradation value 150 (Partial diagram f of FIG. 8B) is diffused to a pixel 1603 as an error, and the error −105 is added to the gradation value of the pixel 1603 to be updated to −105 (Partial diagram r of FIG. 8E).

Similarly for subsequent pixels, the binarization is performed, binary data shown in Partial diagram s of FIG. 8E in which “255” is arranged only in the pixel position indicated by black in the division pattern of the nozzle array B shown in Partial diagram p of FIG. 8E is generated, and the cyan binary data of the nozzle array B of the first pass related to the second plane is obtained.

Similarly, generation of subsequent third to fourth planes is performed. Thus, since subsequent error diffusion processing is performed using the result (k of FIG. 8C) of preceding error diffusion processing, the subsequent error diffusion processing can be performed so that the dot arrangement having little overlapping and little adjoining to the dot arrangement determined by the preceding error diffusion processing can be obtained. Furthermore, the binary data is arranged only at the arrangement permitted position shown by the division pattern of the nozzle array for each of planes.

In other words, in the above processing, the correction data is, as shown in Partial diagram o of FIG. 8D, data having a value by which the value of a pixel to which a dot is to be arranged (for example, pixel 1603) in the plane shown in Partial diagram k of FIG. 8C is made small (−53). This makes it possible to avoid arranging a dot near such a pixel (pixel 1603) in the dot arrangement (Partial diagram s of FIG. 8E) in the corrected cyan plane of the nozzle array B of the first pass. For more details, in the corrected data shown in Partial diagram o of FIG. 8D, the value of the pixel (for example, pixel 1603 having the value of 255) in which a dot is arranged in the cyan plane of the nozzle array A of the first pass shown in Partial diagram k of FIG. 8C is made small. On the other hand, the value of the pixel (pixel having the value of 0) in which a dot is not arranged in the cyan plane of the nozzle array A of the first pass shown in Partial diagram k of FIG. 8C is made large. Accordingly, in the next error diffusion processing, it is not arranged by being adjacent or overlapping to the dot (Partial diagram k of FIG. 8C) of the already generated plane (Partial diagram s of FIG. 8E). Thus, the arrangement with small probability of overlapping mutually can be realized for the dot arrangement of four planes generated in this embodiment. As a result, the dot arrangement which is made by superimposing the dot arrangements distributes excellent, in any combination of four planes. In other words, the frequency spectrum of the dot arrangement obtained by superimposing the planes has less low frequency components. Herein, the “low frequency component” means a component which is in the low frequency side from a half among the spatial frequency areas where a frequency component (power spectrum) exists.

As mentioned above, the information in which pixel the binary data of “225” indicating the dot formation in a certain plane is arranged is reflected so that the data value of the pixel corresponding to the pixel by which the binary data is arranged (of the same position) may be made small for the data of the next plane. In this case, it can also be composed so that the threshold value corresponding to the pixel may become large except corresponding to the case where the data after correction becomes small as shown in FIG. 8. That is, the arrangement information of binary data is reflected so that the data value of corresponding pixel may be made small relatively for the data of the next plane.

Also, although the division pattern indicating whether or not the arrangement as shown in Partial diagram b of FIG. 8A and Partial diagram p of FIG. 8E is allowed is used in this embodiment, the present invention is not limited thereto. For example, the similar result as the division pattern can be obtained by using a method in which the threshold value at the time of performing the error diffusion is made to differ for each of pixels. That is, the threshold value of the position which allows the arrangement is set to 128 and the threshold value of the position which does not allow arrangement is set to 255 which is the maximum so that a pixel can be arranged only at the position to be allowed.

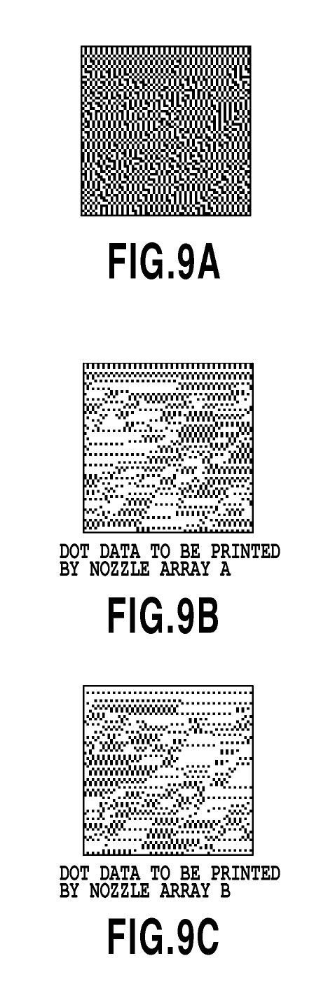

As a comparative example of dot data generation of this embodiment described above, an example which does not perform the error diffusion processing disclosed in Japanese Patent Laid-Open No. 2008-265354 although the assignment of the dot data according to the division pattern shown in FIG. 1 at two nozzle arrays A and B is performed will be explained as followings. When the printing dot data (about 50% of printing ratio) shown in FIG. 9A, as for the dot data printed by each of the nozzle arrays A and B, dots concentrate in a part and the deviation having a low-frequency component occurs as shown in FIG. 9B and FIG. 9C. When speed printing is performed in this state, grain is formed and the image injurious effect so-called beading may be caused as mentioned above.

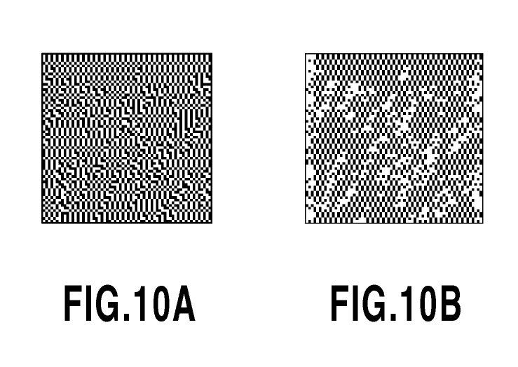

Also, when the deviation having a low-frequency component as shown in FIG. 9B and FIG. 9C has occurred for each of nozzle arrays, image deterioration may occur for a position shift between the nozzle arrays. FIG. 10A expresses a printed image when there is no position shift between the nozzle arrays A and B, and FIG. 10B expresses a printed image when the nozzle array B shifts 3 pixels to the main scanning direction for the nozzle array A. As clearly from this matter, if the deviation of the low-frequency component has occurred for each of nozzle arrays, temporarily, low frequency deviation will occur and image quality will be deteriorated largely when the nozzle array shifts.

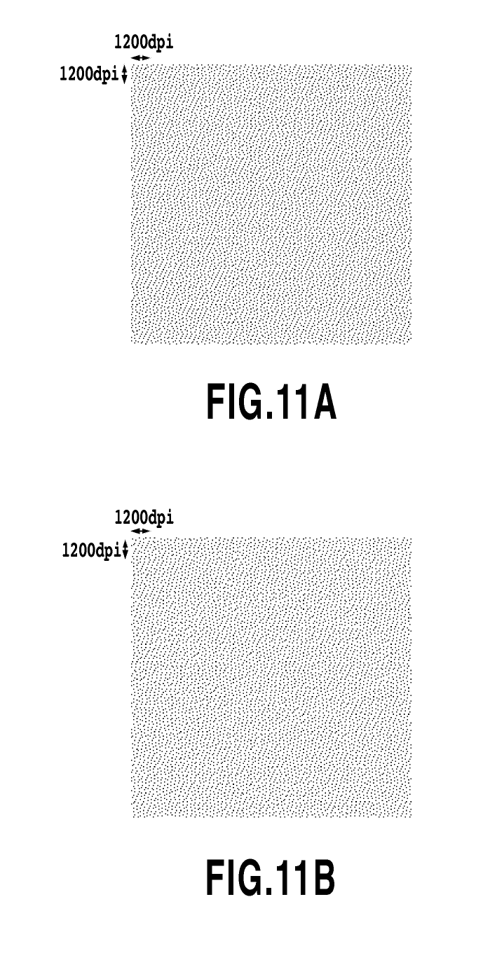

FIG. 11A is a diagram showing dot arrangement of the plane of the first pass of the cyan nozzle array A obtained by the error diffusion processing of this embodiment mentioned above. FIG. 11A expresses comparatively low-concentration gradation with little black dots because of the simplicity of illustration, and shows that the value of all the pixels is 8 bits and the binary data obtained by performing the error diffusion of 12/255 of the multi-valued data. Also, herein, “255” expresses the highest density and “0” expresses the lowest density. FIG. 11B is a diagram showing dot arrangement of the plane of the first pass of the cyan nozzle array B obtained as a result of making the result of the binarization of the first pass of the cyan nozzle array A (FIG. 11A) reflect in the binarization of the first pass of the cyan nozzle array B. At this time, Kc1Ac1B is 0.5. These diagrams show the range of 256 pixels×256 pixels of a certain part among the patterns of the binary image data obtained by the data processing explained by the above-mentioned FIG. 7 and FIGS. 8A-8E by the unit of size of printing width×256 pixels.

As shown in FIG. 11A, the dots are arranged only in the allowable position limited by the nozzle division pattern A shown in FIG. 1, but are arranged with sufficient dispersibility. As similarly shown in FIG. 11B, the result of the binarization of the cyan nozzle array A of the first pass (FIG. 11A) is made to be reflected, and it is further arranged only in the allowable position limited by the nozzle division pattern B, but it proves that it is arranged with sufficient dispersion even by itself. That is, even when the plane is individual, it becomes difficult to occur the deviation of a low-frequency component which does not exist in the original 8-bit data.

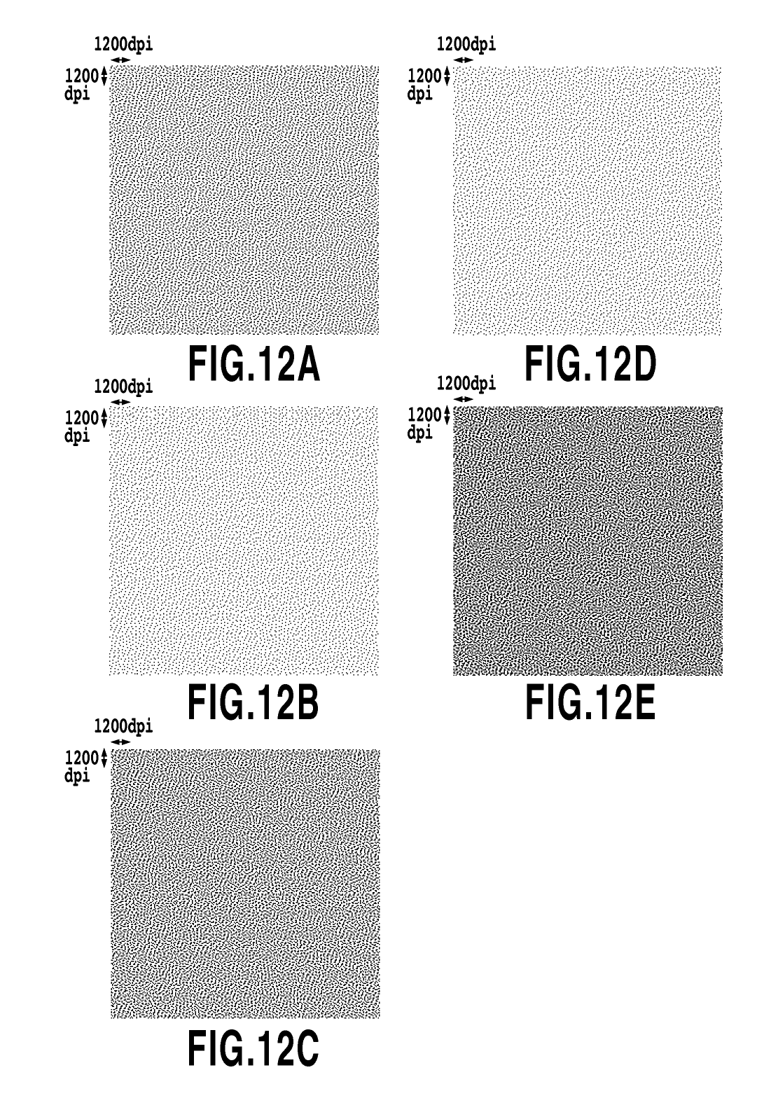

Also, FIG. 12A is a diagram showing dot arrangement of the logical addition between the dot arrangements shown in FIG. 11A and FIG. 11B. Since the result of the binarization of the first pass of the cyan nozzle array A is made to be reflected in the binarization of the first pass of the cyan nozzle array B as shown in FIG. 12A, dispersibility of the dot arrangement of logical addition can also be made high. Furthermore, since the dot arrangement obtained by the processing of this embodiment shown in FIG. 12A is arranged with sufficient dispersion in the state where resolution for the horizontal direction is high, the dispersibility of the dot arrangement of binary data itself is higher.

FIG. 12B is a diagram showing dot arrangement of the second pass of the cyan nozzle array B in the case of reflecting the result of the binarization of the first pass of the cyan nozzle array A (FIG. 11A) and the result of the binarization of the first pass of the cyan nozzle array B (FIG. 11B) in the binarization of the second pass of the cyan nozzle array B. This dot arrangement is an arrangement in which the result of each binarization is reflected by setting both the weighting factor Kc1Ac2B and Kc1Bc2B to 0.5 at the time of reflecting the result of the first pass of the cyan nozzle array A and the first pass of the cyan nozzle array B. Moreover, FIG. 12C is a diagram showing dot arrangement of logical addition between the dot arrangement of the second pass of the cyan nozzle array B shown in FIG. 12B and each dot arrangement of the first pass of the cyan nozzle array A and the first pass of the cyan nozzle array B shown in FIG. 11A and FIG. 11B. Thus, it proves that there is no deviation also in the dot arrangement which superimposed three planes.

Similarly, FIG. 12D is a diagram showing dot arrangement in the plane of the second pass of the cyan nozzle array A which is the result of reflecting the result of the binarization of the first pass of the cyan nozzle array A (FIG. 11A), the result of the binarization of the first pass of the cyan nozzle array B (FIG. 11B), and the result of the binarization of the second pass of the cyan nozzle array B (FIG. 12B) in the error diffusion processing of the second pass of the cyan nozzle array A. Moreover, FIG. 12E is a diagram showing dot arrangement of logical addition between the dot arrangement of the cyan nozzle array A of the second pass shown in FIG. 12D, and each dot arrangement of the first pass of the cyan nozzle array A, the first pass of the cyan nozzle array B, and the second pass of the cyan nozzle array B shown in FIG. 11A, FIG. 11B, and FIG. 12B. Thus, it proves that there is no deviation also in the dot arrangement which superimposed four planes.

As mentioned above, according to the error diffusion processing of this embodiment, the binary data (dot data) of each plane is arranged while the binary data of each plane is distributed excellent. The dot arrangement per nozzle array can abolish the existence of horizontal direction continuous data by arranging the dot data in the position in which the arrangement permission is performed regarding the nozzle arrays A and B maintaining a high print resolution, for example, in the case of the binarization processing of each plane. Thus, it becomes possible to print at double scanning speed in the condition that the ejecting frequency of each nozzle of the nozzle arrays A and B is maintained. On the other hand, it becomes possible to print an image with a high print resolution without reducing the scanning speed by setting the ejecting frequency of each nozzle of the nozzle arrays A and B to one half.

In addition, both the weighting factor Kc1Ac2B and Kc1Bc2Bs related to generation of the plane of the second pass of the cyan nozzle array B can be set to 0.5 as mentioned above regarding a weighting factor. However, it can also be performed as follows as another embodiment.

A weighting factor K at the time that the plane of the second pass of the cyan nozzle array B is generated can be set to Kc1Ac2B=0.2 for the dot arrangement of the first pass of the cyan nozzle array A, and set to Kc1Bc2B=0.5 for the dot arrangement of pass of the cyan nozzle array B. This is because the time period from ejecting the ink in the first pass of the cyan nozzle array A to ejecting ink in the second pass of the cyan nozzle array B is longer than the time period from ejecting the ink in the first pass of the cyan nozzle array B to ejecting the ink in the second pass of the cyan nozzle array B. That is, it is because the influence of the dot arrangement of the first pass of the cyan nozzle array A is made that much small. In this case, the relation for the dot arrangement of the plane of the first pass becomes weaker than the relation between the planes of the first pass.

Thus, the influence of mutually between planes is made small by defining the weighting factor corresponding to a large or small interval of the ink ejecting timing between each plane, and setting the value of the weighting factor small as this interval becomes long. This is because a possibility that the ink ejected is absorbed into a print medium becomes high as the above-mentioned interval became long, therefore a probability formed while the grain contacts on the print medium becomes small. Also, between different passes, the weighting factor is relatively decreased between the planes of the same nozzle array. This is because of improving the dispersibility between the same nozzle arrays by decreasing the influence of mutually between the planes of the same nozzle array.

According to the above-mentioned embodiment, it decides for the dot arrangement of the following plane with reference to the dot arrangement result of all the planes formed previously in the order of formation of dots of each plane. However, only the dot arrangement result of a specific plane may be referred to as required. For example, when deciding the dot arrangement of the plane of the second pass of the cyan nozzle array A, a configuration of only taking in consideration of the result of the plane which wishes to avoid the superimposing relatively (plane of the second pass of the cyan nozzle array B), and not taking into consideration the result of the other plane (the plane of the first pass of the cyan nozzle array A, the plane of the first pass of the cyan nozzle array B) may be suitable.

That is, it is considered of the case where the error diffusion is performed one after another from the first to NK^{th} data for each multi-valued image data of the N×K kind corresponding to N scanning (where N is integer greater than or equal to 2) and the nozzle array of K colors (where K is integer greater than or equal to 2). In this case, it is effective also as a configuration which performs the X^{th} (1<x<NK) error diffusion processing based on the result of less kinds of the error diffusion processing rather than the X−1 kind from among X−1 kinds of error diffusion processing performed from 1st to (X−1)^{th}.

Moreover, although the dot arrangement is defined by associating all the passes in the above-mentioned embodiment, it is not necessary to define dot arrangement by associating all the passes and it is also possible to associate only about a certain specific pass. For example, it may be a form which performs a characteristic error diffusion processing mentioned above for only about the first pass of nozzle arrays. Also, a certain specific nozzle array may be selected and a specific pass among the nozzle array may be associated.

As explained above, according to the first embodiment of the present invention, the dot of each plane fully distributes and then is formed. As a result, the probability which ink having unsatisfactory permeation contacts and makes a grain because of the relative relation between the ink and the print medium even if the permeation of ink is not fully performed in the stage of the intermediate image in which a printed image is not completed will become low, and thereby, the so-called occurrence of beading can be suppressed. Also, since it will become the distribution having little low-frequency components distributed excellent also about these grains and beading even if the beading occurs by the above-mentioned grain's existing and shifting and superimposing between the nozzle arrays, the influence which they have on the quality of printed image can be reduced.

Also, if it takes into consideration that the ink permeation does not necessarily need to be performed fully in the stage of an intermediate image as a result in this manner, in the printer 104, it will become possible to shorten, the printing time difference, i.e., the ejecting time difference, between respective planes. It can execute printing with fewer two passes for the part which is making the number of passes in the multi-pass printing as four passes in consideration of the ink fully permeating, for example. Furthermore, it becomes possible to abolish the existence of the continuous data in the scanning direction to the dot arrangement for each of nozzle arrays by arranging binary data only in the position by which the arrangement permission is performed by the division pattern regarding the nozzle array in the case of the processing of each plane, as mentioned above.

In addition, the similar configuration as the above-mentioned is applicable also to the printing system using the ink or the like of a reaction system which generates an insoluble product by the mixture of an ink and a transparent and colorless fluid, or mixture of the inks. That is, dot distribution with which a plurality of planes superimposed can be made distribution of excellent dispersibility with less low-frequency components by performing the similar error diffusion processing as mentioned above about the plane of the binary data for reaction system ink or a reaction system fluid. Accordingly, in the stage of intermediate image, for example, probability that adjoining inks having unsatisfactory permeation will react unnecessarily and the grain of insoluble product will be formed can be made small, and the grain can be made not conspicuous even if such a grain is generated.

### Second Embodiment

The first embodiment mentioned above is the case where the bidirectional printing is performed as the printing order at the time of the printing with two passes. However, one way-printing can also be used as a printing direction. A second embodiment of the present invention is related with one way printing.

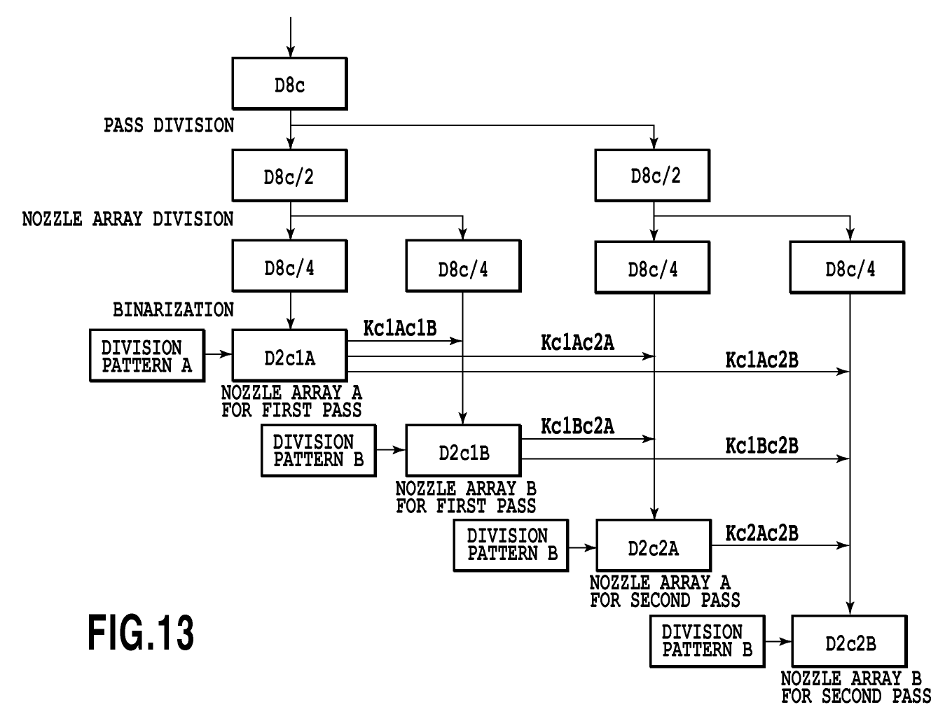

FIG. 13 is a diagram for explaining contents of the second embodiment of pass division processing, block division processing, and binarization processing of Step S404, S405 and S406 shown in FIG. 6. In particular, the processing order for every scanning is the same, and it processes as well as the first embodiment except that the dot data generating sequence of the second pass differs.

In FIG. 13, multi-valued data D8c of 8 bits of cyan every pixel obtained at step S403 is divided into data D8c/2 whose pixel value is set as ½ by the pass division processing. Furthermore, by the nozzle array division, the pixel value is divided into ½, i.e., into D8c/4 which is ¼ compared with the initial pixel value. Accordingly, the multi-valued data of the first pass of the cyan nozzle array A, the first pass of the cyan nozzle array B, the second pass of the cyan nozzle array A, and the second pass of the cyan nozzle array B are generated, respectively.

Then, binary data D2c1A and D2c1B of the first pass of the cyan nozzle array A and the first pass of the cyan nozzle array B are calculated by the similar processing as the first embodiment.

Next, in third generation of the plane of the nozzle array A of the second pass of cyan, correction which adds the correction term (Kc1Ac2A(D8c/4−D2c1A)+Kc1Bc2A(D8c/4−D2c1B)) as a result of the first or second error diffusion is performed for the multi-valued data D8c/4. Then, the binarization is performed on the corrected multi-valued data [D8c/4+(Kc1Ac2A(D8c/4−D2c1A)+Kc1Bc2A(D8c/4−D2c1B))], and cyan binary data D2c2A of the nozzle array A of the second pass is calculated. In the error diffusion at this time, the binary data is arranged only at the arrangement permitted position shown by the division pattern A shown in FIG. 1.

Similarly, in fourth generation of the plane of the cyan nozzle array B of the second pass, correction which adds the correction term (Kc1Ac2B(D8c/4−D2c1A)+Kc1Bc2B(D8c/4−D2c1B)+Kc2Bc2B(D8c/4−D2 c2B)) by the result of the first, second and third error diffusion is performed on the multi-valued data D8c/4. Then, binarization is performed for the corrected multi-valued data [D8c/4+(Kc1Ac2B(D8c/4−D2c1A)+Kc1Bc2B(D8c/4−D2c1B)+Kc2Bc2B(D 8c/4−D2c2B))], and binary data D2c2B of the second pass of the cyan nozzle array A is calculated. Similarly, in this error diffusion processing, the binary data is arranged only at the arrangement permitted position shown by the division pattern B.

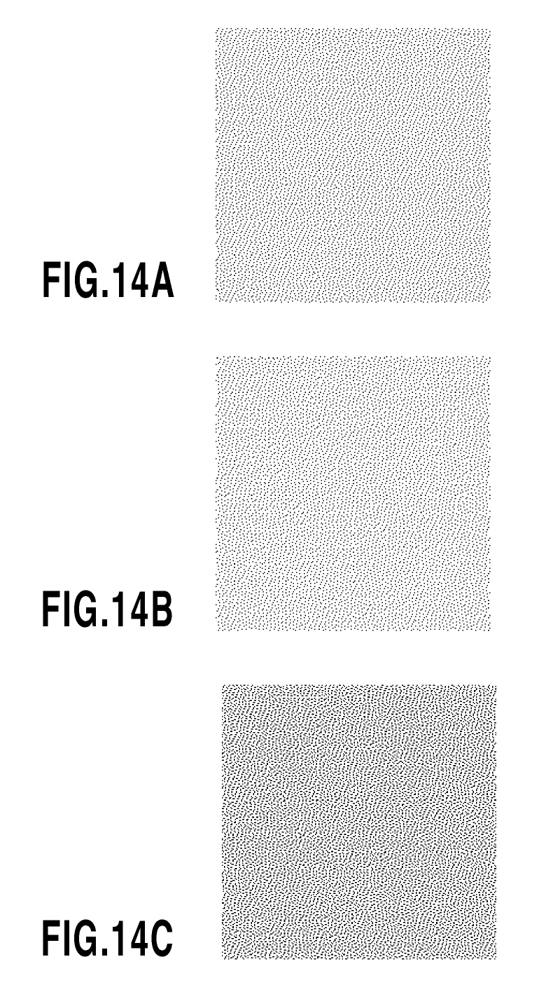

FIG. 14A and FIG. 14B are diagrams showing the dot arrangements of each plane of the first pass of the cyan nozzle array A and the first pass of the cyan nozzle array B. Such dot arrangement is processed as well as the first embodiment, as mentioned above. FIG. 14C is a diagram showing dot arrangement of the logical addition between the dot arrangements shown in FIG. 14A and FIG. 14B. As shown in these diagrams, both the dot arrangement of an individual plane and the dot arrangement of those logical additions are proved that the dispersibility is high.

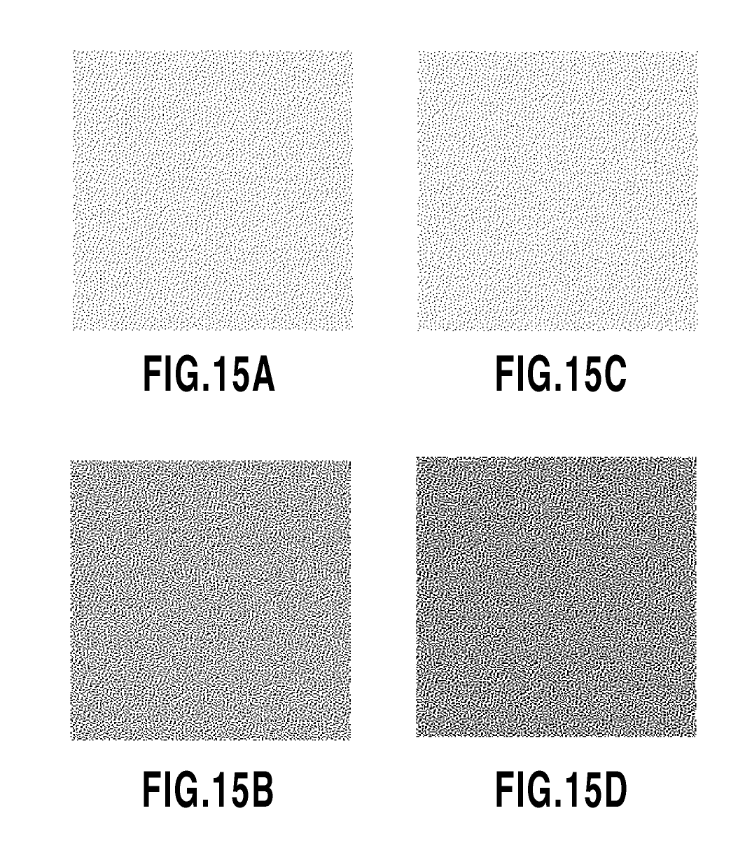

FIG. 15A is a diagram showing a dot arrangement in the plane of the second pass of the cyan nozzle array A in the case of reflecting the result of the binarization of the first pass of the cyan nozzle array A (FIG. 14A) and the result of the binarization of the first pass of the cyan nozzle array B (FIG. 14B) according to of the second embodiment mentioned above in the binarization of the nozzle array A of the second pass of cyan. This dot arrangement is an arrangement which both weighting factor Kc1Ac2B and Kc1Bc2B is reflect to 0.5 regarding the first pass of the cyan nozzle array A and the first pass of the cyan nozzle array B, and the result of the binarization of FIG. 14A and FIG. 14B is reflected. Also, FIG. 15B is a diagram showing dot arrangement of logical addition between the dot arrangement of the second pass of the cyan nozzle array A shown in FIG. 15A and each dot arrangement of the first pass of cyan nozzle arrays A and B shown in FIG. 14A and FIG. 14B. Thus, it proves that there is no deviation of dot arrangement also in the dot arrangement which superimposed three planes.

FIG. 15C is a diagram showing dot arrangement in the plane of the second pass of the cyan nozzle array B in the case of reflecting the result of the binarization of the first pass of the cyan nozzle array A (FIG. 14A), the result of the binarization of the first pass of the cyan nozzle array B (FIG. 14B), and the result of binarization of the second pass of the cyan nozzle array A (FIG. 15A) in the binarization processing of the second pass of the cyan nozzle array B. Also, FIG. 15D is a diagram showing dot arrangement of the logical addition between the dot arrangement of the second pass of the cyan nozzle array B shown in FIG. 15C and each dot arrangement of the first pass of the cyan nozzle array A, the first pass of the cyan nozzle array B, and the second pass of the cyan nozzle array A shown in FIG. 14A, FIG. 14B, and FIG. 15A. Thus, it proves that there is no deviation also in the dot arrangement which superimposed four planes.

Note that, both of the dot arrangement at the time that the four planes obtained by the first embodiment are superimposed (FIG. 12E), and the dot arrangement obtained by the second embodiment (FIG. 15D) are arranged with sufficient dispersion. However, in the second embodiment related to the one way printing, when printing using the dot arrangement obtained by the first embodiment related to the bidirectional printing, the beading may occur.

### Third Embodiment

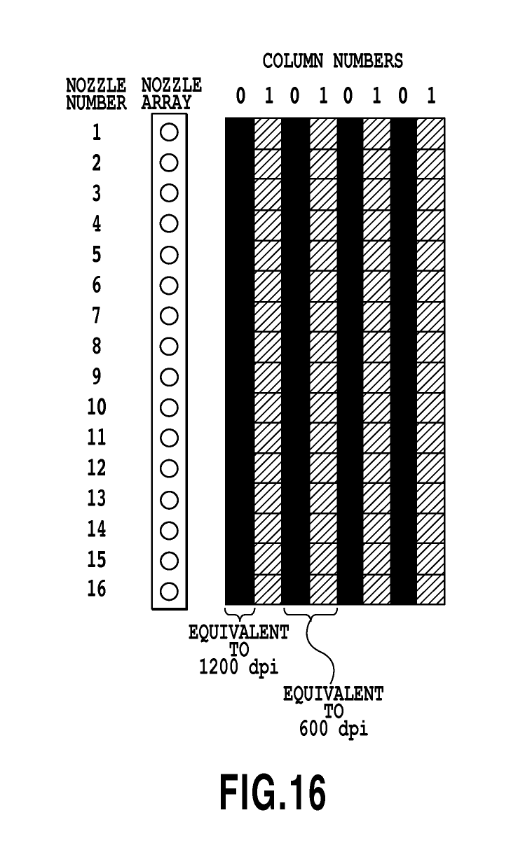

The third embodiment of the present invention relates to a configuration in which the thinned printing is performed with use of a column thinning mentioned above. FIG. 16 is a diagram for explaining the column thinning. An example of the column thinning shown in FIG. 16, pixel arrays different from each other (pixel array along a nozzle arranging direction; column) is printed by two scanning using one nozzle array for one ink color. That is, in each scanning, each nozzle of the nozzle array prints a corresponding pixel in alternate columns. Thus, in the case of printing by multiple scanning of the printing head, the division pattern shown in FIG. 16 is a pattern which defines the scanning which prints the image divided among a plurality of scanning, and the arrangement permitted position according to the division pattern has a relationship of exclusion between a plurality of scanning. Then, when the error diffusion processing disclosed in Japanese Patent Laid-Open No. 2008-265354 is used for generating dot data (binary data), the pattern of the column thinning shown in FIG. 16 becomes an arrangement permitted position of each scanning regarding the dot arrangement.

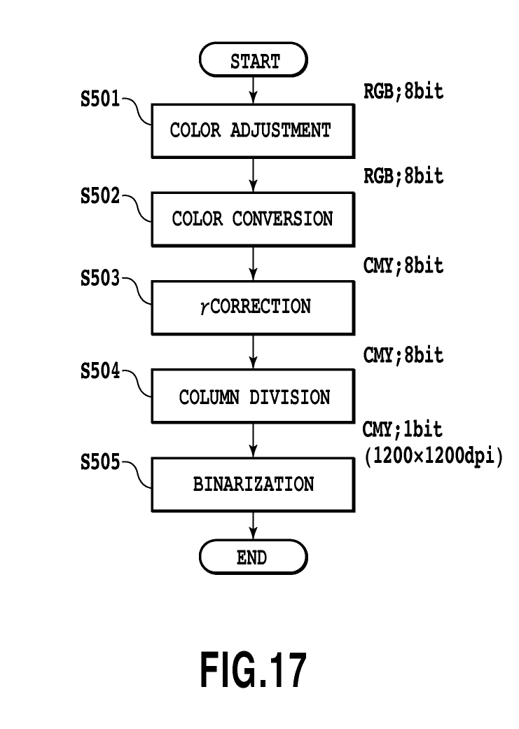

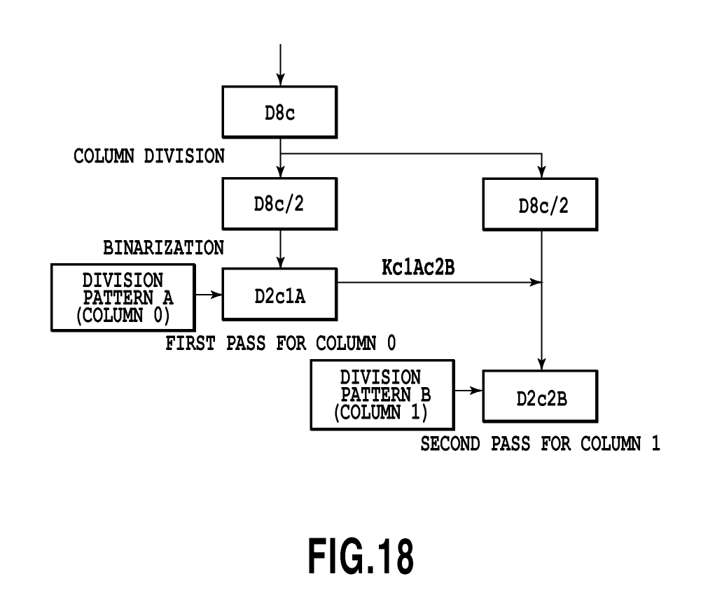

FIG. 17 is a flow chart showing a procedure of image processing according to the third embodiment of the present invention. Steps S501 to S503 among the processing shown in FIG. 17 are the same as the processing of Steps S401 to S403 mentioned above with FIG. 6. FIG. 18 is a diagram for explaining a concept of column division and binarization processing of Steps S504 and S505. The points that these processing differ from each embodiment mentioned above substantially are the contents of the pattern of the arrangement permitted position in the error diffusion processing which performs the binarization. That is, in this embodiment, the pattern shown in FIG. 16 becomes the arrangement permitted position when performing the error diffusion processing of the plane of each scanning. For more details, since the column indicated by black is printed by the first scan (first pass), as for the pixel of this column, the arrangement of the dot is allowed when generating the dot data of the first pass. On the other hand, since the column shown by slashes is printed by the second scan (second pass), as for the pixel of this column, the arrangement of the dot is allowed when generating the dot data of the second pass. Conversely, when generating the dot data of the scanning which is not applicable, in the error diffusion processing for the binarization, the pattern of these columns will limit the dot arrangement.

As shown in FIG. 18, 8-bit multi-valued data D8c of cyan per pixel obtained at Step S503 is divided into two data of D8c/2 by the column division, and is set to be the multi-valued data (column 0) for the first passes of cyan and the multi-valued data (column 1) for the second passes of cyan, respectively.

Next, cyan binary data (dot data) D2c1A of the first pass is calculated by the same error diffusion processing as mentioned above with FIG. 7 etc. In the error diffusion at this time, the pixel of the column indicated by black in FIG. 16 becomes the arrangement permitted position, and the dot data are arranged only at this position.

Next, in the second generation of the cyan dot data of the plane of the second pass (column 1), correction which adds the correction term (Kc1Ac2B(D8c/2−D2c1A)) to the divided multi-valued data D8c/2 according to the result of the first error diffusion is performed. Then, the error diffusion processing is performed for the corrected multi-valued data (D8c/2+(Kc1Ac2B (D8c/2−D2c1A)), and cyan binary data D2c2B of the second pass is calculated. In the error diffusion processing at this time, the pixel of the column shown by the slashes in FIG. 16 becomes the arrangement permitted position, and the dot data is arranged only at this position.

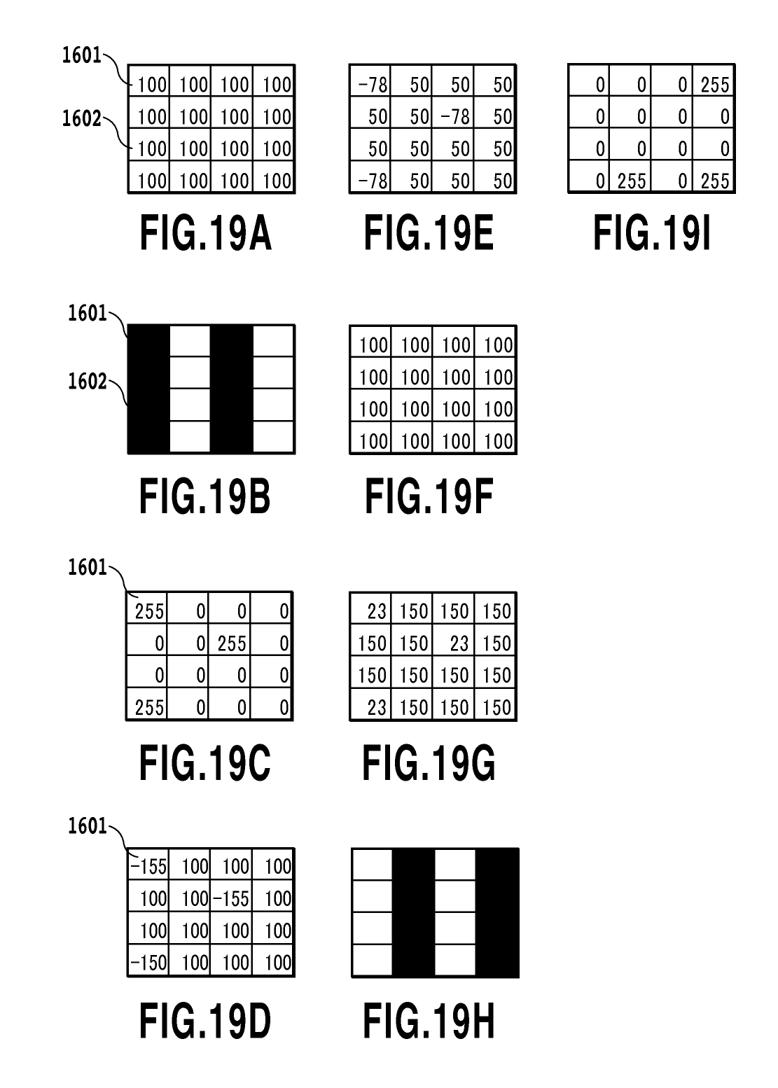

FIGS. 19A-19I are diagrams for explaining the binarization processing explained with FIG. 18 according to the contents of data.

FIG. 19A shows cyan 8-bit multi-valued data D8c/2 of the first pass. FIG. 19B shows the division pattern indicating the arrangement permitted position in the error diffusion processing of the first pass of cyan, and the position indicated by black shows the arrangement permitted position. Here, in order to explain simply, the case where the pixel value is 100 is shown. FIG. 19C shows binary data D2c1A obtained by the error diffusion processing for the multi-valued data D8c/2. The binary data of FIG. 19C is calculated by the error diffusion processing taking into consideration the allowable position shown in FIG. 19B as explained in the first embodiment. That is, the dot data shown in FIG. 19C is arranged only at the pixel (position) indicated by black in the division pattern A of FIG. 19B.

Next, FIG. 19D shows the correction data generated using the multi-valued data D8c/2 and the binary data D2c1A. Then, this correction data is added to the cyan multi-valued data D8m/2 of the second pass related to the second plane generation. At this time, Kc1Ac2B is used as a weighting factor of the correction data. Here, the correction data is added to the cyan multi-valued data of the first pass as it is when Kc1Ac1B=1, and the half of the correction data value is added to the cyan multi-valued data of the second pass when Kc1Ac2B=0.5. Kc1Ac2B=0.5 is set in the example shown in FIG. 19D. FIG. 19E shows the correction data at this time. Then, by using the correction data shown in this FIG. 19E, the cyan multi-valued data D8c/2 of the second pass shown in FIG. 19F is corrected. FIG. 19G shows the multi-valued data after this correction, and is expressed as the sum of the data shown in FIG. 19E and FIG. 19F.

Then, cyan binary data D2c2B of the second pass shown in FIG. 19I related to the second plane is obtained by performing the error diffusion processing for the multi-valued data of FIG. 19G. At this time, the binary data shown in FIG. 19I is obtained by the error diffusion processing in consideration of the allowable position of the division pattern shown in FIG. 19H. That is, the dot data is arranged only at the position indicated by black in the division pattern of FIG. 19H.

According to the third embodiment mentioned above, the image having high resolution can be printed at high speed in half resolution by one scanning, and the occurrence of beading can be suppressed.

Note that, in the third embodiment mentioned above, although the explanation was made for the case where the dot data of two passes are generated, the present invention is applicable with any numbers of passes including three passes and four passes. In this case, in the generation of a plurality of planes corresponding to each ink color and each scanning, the processing result of a certain plane is reflected in another plane according to the correction term one after another, as explained in the above-mentioned embodiment.

Although the above-mentioned embodiment has been explained with the example of the multi-pass printing using C ink, it is clear that the present invention is applicable also to dot data generation of a plurality of planes corresponding to scanning frequency in the multi-pass printing in the case of using C, M, Y, and K inks.

### Other Embodiments

Although each above-mentioned embodiment has bee explained with the example that the error diffusion processing is performed with the host device, it is needless to say that the configuration which can be applied to the present invention is not limited to this form. For example, the error diffusion processing may be executed in the printing apparatus explained with FIG. 2, FIG. 3, etc.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-172437, filed Jul. 23, 2009, which is hereby incorporated by reference herein in its entirety.

What is claimed is:

1. An image data generating apparatus comprising:
a dividing unit configured to divide multi-valued image data to be printed on a unit area of a print medium into a plurality of multi-valued data including a first multi-valued data and a second multi-valued data; and
a generating unit configured to generate binary data indicating printing or non-printing for each of pixels of the unit area, according to the plurality of multi-valued data and a plurality of arrangement permitting data that determine whether arrangement of data indicating printing is permitted in each of pixels of the unit area,
wherein an arrangement of arrangement permitting data determining that the arrangement of data indicating printing is permitted, which is used for the first multi-valued data by said generating unit, is different from an arrangement of arrangement permitting data determining that the arrangement of data indicating printing is permitted, which is used for the second multi-valued data by said generating unit.

2. The image data generating apparatus as claimed in claim 1, wherein said generating unit uses error diffusion processing to generate the binary data.

3. The image data generating apparatus as claimed in claim 2, wherein said generating unit generates the binary data indicating printing for a object pixel when density value of the object pixel in the unit area is greater than a threshold value in the error diffusion processing and when the arrangement permitting data determines that the arrangement of data indicating printing is permitted in the object pixel, and generates the binary data indicating non-printing for the object pixel when the density value of the object pixel in the unit area is equal to or smaller than the threshold value or when the arrangement permitting data determines that the arrangement of data indicating printing is not permitted in the object pixel.

4. The image data generating apparatus as claimed in claim 3, wherein said generating unit diffuses difference between the density of the object pixel and the threshold value to peripheral pixels of the object pixel when density value of the object pixel in the unit area is greater than a threshold value in the error diffusion processing and when the arrangement permitting data determines that the arrangement of data indicating printing is permitted in the object pixel, and diffuses the density of the object pixel to peripheral pixels of the object pixel when the density value of the object pixel in the unit area is equal to or smaller than the threshold value or when the arrangement permitting data determines that the arrangement of data indicating printing is not permitted in the object pixel.

5. The image data generating apparatus as claimed in claim 1, wherein the arrangement permitting data used for the first multi-valued data and the arrangement permitting data used for the second multi-valued data have exclusive relationship with each other.

6. The image data generating apparatus as claimed in claim 1, wherein said generating unit performs generation of the binary data from the plurality of multi-valued data sequentially and generates the subsequent binary data based on the binary data previously generated.

7. The image data generating apparatus as claimed in claim 1, further comprising storage unit configured to store the plurality of arrangement permitting data.

8. A printing apparatus that prints an image by a relative scan of a printing head provided with a plurality of nozzle arrays and a print medium, said apparatus comprising:
a dividing unit configured to divide multi-valued image data to be printed on a unit area of the print medium into a plurality of multi-valued data including a first multi-valued data and a second multi-valued data;
a generating unit configured to generate binary data indicating printing or non-printing for each of pixels of the unit area, according to the plurality of multi-valued data and a plurality of arrangement permitting data that determine whether arrangement of data indicating printing is permitted in each of pixels of the unit area, and
a print control unit configured to control printing to the unit area based on the first multi-valued data and printing to the unit area based on the second multi-valued data,
wherein an arrangement of arrangement permitting data determining that the arrangement of data indicating printing is permitted, which is used for the first multi-valued data by said generating unit, is different from an arrangement of arrangement permitting data determining that the arrangement of data indicating printing is permitted, which is used for the second multi-valued data by said generating unit.

9. The printing apparatus as claimed in claim 8, wherein
the plurality of nozzle arrays include two nozzle arrays ejecting a same color of ink, and
said print control unit controls the printing based on the first multi-valued data to be performed using one of the two nozzle arrays and controls the printing based on the second multi-valued data to be performed using the other of the two nozzle arrays.

10. The printing apparatus as claimed in claim 8, wherein
printing to the unit area is performed by a plurality of relative scans of the printing head and
said print control unit controls the printing based on the first multi-valued data and the printing based on the second multi-valued data to be performed respectively in different relative scans among the plurality of relative scans.

11. An image data generating method comprising:
a dividing step of dividing multi-valued image data to be printed on a unit area of a print medium into a plurality of multi-valued data including a first multi-valued data and a second multi-valued data; and
a generating step of generating binary data indicating printing or non-printing for each of pixels of the unit area, according to the plurality of multi-valued data and a plurality of arrangement permitting data that determine whether arrangement of data indicating printing is permitted in each of pixels of the unit area,
wherein an arrangement of arrangement permitting data determining that the arrangement of data indicating printing is permitted, which is used for the first multi-valued data in said generating step, is different from an arrangement of arrangement permitting data determining that the arrangement of data indicating printing is permitted, which is used for the second multi-valued data in said generating step.
